(19) United States
(12) Patent Application Publication
(10) Pub. No.: US 2008/0066067 A1
(43) Pub. Date: Mar. 13, 2008

(54) Enterprise performance management software system having action-based data capture

(75) Inventors: Mark Stimpson, Ruislip (GB); Andrew Thomas Nelmes, London (GB)

Correspondence Address: SHUMAKER & SIEFFERT, P. A., 1625 RADIO DRIVE, SUITE 300, WOODBURY, MN, 55125, US

(73) Assignee: Cognos Incorporated, Ottawa (CA)

(21) Appl. No.: 11/891,570

(22) Filed: Aug. 10, 2007

Related U.S. Application Data
(60) Provisional application No. 60/842,905, filed on Sep. 7, 2006.

(51) Int. Cl. G06F 9/46

(52) U.S. Cl. 718/100

(57) ABSTRACT

Techniques are described of entering and presenting data in an enterprise planning and performance management system. As disclosed herein, the techniques facilitate the capture and entry of data into an underlying multidimensional dataset through action-based forms. In addition, the techniques allow reviewers to use spreadsheet-like views of the captured data. In certain embodiments, the techniques also facilitate straightforward review of changes to data within the spreadsheet-like views by providing a task log that enables reviewers to more readily review, accept, or dismiss such changes.

This application claims the benefit of U.S. Provisional Application No. 60/842,905 filed Sep. 7, 2006, the entire content of which is incorporated herein by reference.

### TECHNICAL FIELD

The invention relates to enterprise computing environments, and more particularly, to enterprise performance management systems.

### BACKGROUND

Enterprise software systems are typically sophisticated, large-scale systems that support many, e.g., hundreds or thousands, of concurrent users. Examples of enterprise software systems include financial planning systems, order management systems, inventory management systems, sales force management systems, business intelligence tools, enterprise reporting tools, project and resource management systems and other enterprise software systems.

Many enterprise performance management and business planning software systems require a large population of users to submit data that the software systems then accumulate into higher level areas of responsibility in the organization. The software systems may perform mathematical calculations on the data, combining data submitted by one user with data submitted by another. Using the results of these calculations, the software systems may generate reports for review by higher management.

To collect this data, the software systems typically present users with unstructured grid views or complex spreadsheet-like screens within which they are to submit their data. However, these mechanisms are difficult to manipulate and use and, therefore, are not easily used by the wide variety of users that may be present in a given organization. In general, these mechanisms present a wide variety of options that the users must choose between when submitting data. Because of these options, the users may submit incorrect data. Further, these mechanisms may make delegation of specific portions of data submission cumbersome, as the users must interact with the entire grid to submit data. Moreover, these mechanisms typically require tedious rearrangement and/or reentry of interrelated data within the spreadsheet-like screens should time delays arise with respect to the business process being managed.

### SUMMARY

The invention is directed to techniques of entering and presenting data in an enterprise planning and performance management system. As disclosed herein, the techniques facilitate the capture and entry of data into an underlying multidimensional dataset through action-based forms. In addition, the techniques allow reviewers to use spreadsheet-like views of the captured data. In certain embodiments, the techniques also facilitate straightforward review of changes to data within the spreadsheet-like views by providing a task log that enables reviewers to more readily review, accept, or dismiss such changes.

In accordance with the techniques, an action-based enterprise planning and performance management software system stores enterprise planning data in a multidimensional dataset. Furthermore, the techniques allow analysts to use spreadsheet-like views to enter business-as-usual data into the multidimensional dataset. The business-as-usual data represents typical expenses of the enterprise. In addition, the techniques allow the analysts to create task-specific forms that allow contributors within the enterprise to enter enterprise data related to specific tasks into the multidimensional dataset without the use of the spreadsheet-like views. Because these task-specific forms are specific to individual types of tasks that contributors perform, the task-specific forms may be easier for the contributors to use than the spreadsheet-like views. Furthermore, in accordance with the techniques, the software system may automatically aggregate the business-as-usual data and the task-specific contribution data to form aggregate contribution data.

Reviewers can review forecasts based on the aggregate contribution data in order to determine whether to accept or reject the task-specific contribution data entered by the contributors. For instance, the software system allows reviewers to review the contribution data captured via the action-based forms, and may also provide task logs by which the reviewers can accept, reject, and review changes to tasks, thereby affecting changes within a spreadsheet-like view presented in conjunction with the task log.

Furthermore, the techniques allow analysts to define relationships among tasks. For instance, the techniques may allow analysts to define chronological dependencies among a set of tasks. In one example, the techniques may allow an analyst to specify the task A must be completed 90 days before task B may begin. In addition, the software system may automatically adapt to temporal changes to tasks associated with a set of action data. For example, a time delay experienced with respect to one task may cause the software system to automatically update the set of action data to rearrange or redefine tasks that are related to the changed task.

In one embodiment, a computer-implemented method of performing an enterprise planning session comprises receiving model data that defines an enterprise planning model for use within a subsequent enterprise planning session. The model data comprises action data that specifies one or more tasks, and wherein the action data defines: (i) a plurality of task-specific forms to capture task-specific contribution data for the enterprise planning session on a per-task basis, and (ii) a mapping for storing the task-specific contribution data within a database of multidimensional data. In addition, the method comprises executing software to conduct the enterprise planning session in accordance with the model at least in part by capturing business-as-usual contribution data associated with ordinary operation of the enterprise from a first set of contributors using a spreadsheet interface, capturing the task-specific contribution data associated with out-of-the-ordinary operations of the enterprise from a second set of contributors using the task-specific forms and storing the task-specific contribution data within the database according to the mapping, aggregating the task-specific contribution data and the business-as-usual contribution data to form aggregate contribution data for the enterprise planning session, and generating a composite forecast from the aggregate contribution data.

In another embodiment, a computing system comprises an analysis software module executing on the computing system to receive model data that defines an enterprise planning session to be carried out by a set of users associated with a multi-level enterprise hierarchy. The model data comprises action data that specifies one or more tasks, and wherein the action data defines (i) a plurality of task-specific forms to capture task-specific contribution data for the enterprise planning session on a per-task basis, and (ii) a mapping for storing the task-specific contribution data within a database of multidimensional data. In addition, the computing system comprises a contribution module executing on the computing system to conduct the enterprise planning session in accordance with the model at least in part by capturing business-as-usual contribution data associated with ordinary operation of the enterprise from a first set of contributors using a spreadsheet interface. The contribution module also causes the computing system to conduct the enterprise planning session by capturing the task-specific contribution data associated with out-of-the-ordinary operations of the enterprise from a second set of contributors using the task-specific forms and storing the task-specific contribution data within the database according to the mapping. In addition, the contribution module causes the computing system to conduct the enterprise planning session by aggregating the task-specific contribution data and the business-as-usual contribution data to form aggregate contribution data for the enterprise planning session. The contribution module also causes the computing system to conduct the enterprise planning session by generating a composite forecast from the aggregate contribution data.

In another embodiment, a computer-readable medium comprises instructions. When executed by a programmable processor, the instructions cause the programmable processor to retrieve model data that defines an enterprise planning model for use within a subsequent enterprise planning session. The model data comprises action data that specifies one or more tasks, and wherein the action data defines: (i) a plurality of task-specific forms to capture task-specific contribution data for the enterprise planning session on a per-task basis, and (ii) a mapping for storing the task-specific contribution data within a database of multidimensional data. In addition, the instructions cause the programmable processor to execute software to conduct the enterprise planning session in accordance with the model at least in part by causing the programmable processor to capture business-as-usual contribution data associated with ordinary operation of the enterprise from a first set of contributors using a spreadsheet interface. The instructions also cause the programmable processor to conduct the enterprise planning session in accordance with the model at least in part by causing the programmable processor to capture the task-specific contribution data associated with out-of-the-ordinary operations of the enterprise from a second set of contributors using the task-specific forms and storing the task-specific contribution data within the database according to the mapping. The instructions also cause the programmable processor to conduct the enterprise planning session in accordance with the model at least in part by causing the programmable processor to aggregate the task-specific contribution data and the business-as-usual contribution data to form aggregate contribution data for the enterprise planning session. In addition, the instructions also cause the programmable processor to conduct the enterprise planning session in accordance with the model at least in part by causing the programmable processor to generate a composite forecast from the aggregate contribution data.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a computing environment in which an enterprise planning and performance management system uses action-based enterprise management techniques.

FIG. 2 is a flowchart illustrating an exemplary operation of the enterprise planning and performance management system of FIG. 1.

FIG. 3 is a block diagram illustrating one example embodiment of the enterprise planning and performance management system of FIG. 1.

FIG. 4 is a block diagram illustrating an exemplary computing device, including various software modules executing thereon, when operated by a user, such as a contributor or a reviewer.

FIGS. 5A-5E show screenshots of exemplary user interfaces presented by the computing device of FIG. 4.

FIG. 6 shows a screenshot of another exemplary user interface presented by the computing device of FIG. 4 to a user.

FIG. 7 shows another screenshot of an exemplary software application, where the enterprise planning and performance management system of FIG. 4 interacts with the software application to present an alert window.

FIG. 8 shows another exemplary user interface presented by the computing device of FIG. 4.

FIG. 9 is a screenshot illustrating an exemplary task-specific form by which a user may enter task-specific contribution data regarding a new action.

FIG. 10 is a screenshot illustrating an exemplary action editing interface.

FIG. 11 is a screenshot illustrating an exemplary task-specific form in which a user is configuring an action to recur.

FIG. 12 is a screenshot illustrating an exemplary action review interface presented by the computing device of FIG. 4.

FIG. 13 is a screenshot illustrating an exemplary action review interface that includes a set of input boxes to filter actions in an action pane.

FIG. 14 is a screenshot illustrating an exemplary carry-forward interface presented by the computing device of FIG. 4.

FIG. 15 is a screenshot illustrating a forecast interface presented by the computing device of FIG. 4 in which a user views a forecast as it would appear if actions that occurred after a selected date had not occurred.

FIG. 16 is a screenshot illustrating an example variable editing interface presented by the computing device of FIG. 4.

### DETAILED DESCRIPTION

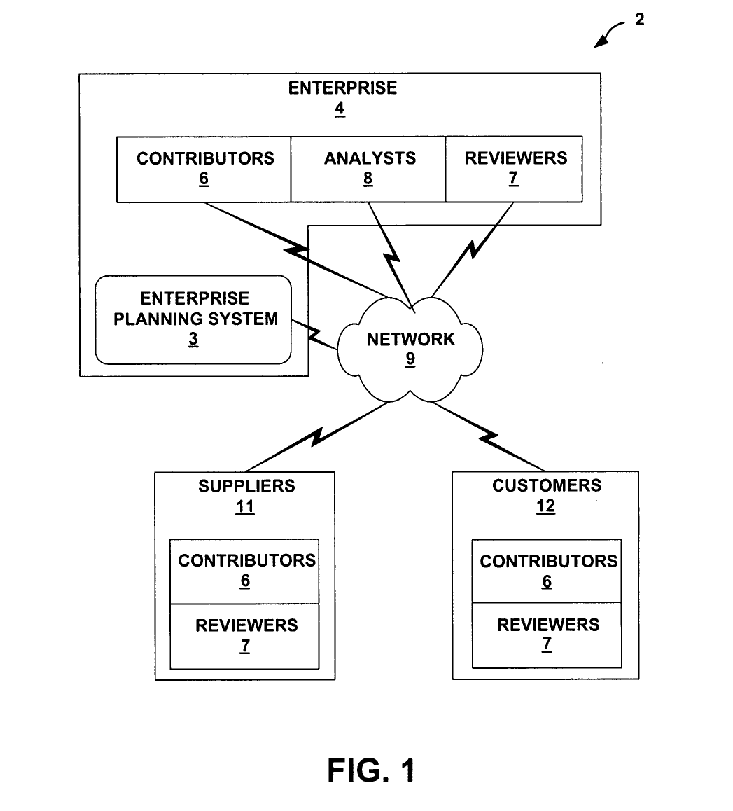

FIG. 1 is a block diagram illustrating an environment 2 in which an enterprise planning and performance management system 3 (referred to herein after as “system 3”) uses action-based data management techniques. In general, system 3 provides three stages of enterprise planning: (1) a modeling stage, (2) a contribution stage, and (3) a reconciliation (review) stage. In the modeling stage, a team of analysts 8, such as the chief financial officer, senior financial analysts or product and sales analysts, define requirements and build planning models for an enterprise 4. In this example, analysts 8 develop a model having an organizational hierarchy. The organizational hierarchy may include a number of hierarchically arranged nodes representing various organizational units (e.g., cost centers or departments) within enterprise 4.

During the modeling stage, analysts 8 may establish corporate targets for each node of the organizational hierarchy. Analysts 8 then assign one or more contributors 6 to each node. Contributors 6 may include enterprise users such as managers, supervisors, sales representatives, lab managers, or the like, that are responsible for enterprise planning for a corresponding organizational unit. Each reviewer in a set of reviewers 7 accepts or rejects contribution data submitted by contributors 6. Contributors 6 and reviewers 7 may be authorized users within enterprise 4 or within other entities coupled to network 9, such as suppliers 10 and customers 11.

Furthermore, during the modeling stage, analysts 8 may configure the model to include one or more sets of action data. During the modeling stage, analysts 8 may also edit preexisting sets of action data. Each set of action data may define one or more actions that relate to an unusual or out-of-the-ordinary business process. As used in this disclosure, an out-of-the-ordinary business process is a business process that does not recur on a predictable basis during the course of day-to-day operations. A set of action data for an action may be associated with one for more tasks. When a set of action data for an action is associated with more than one task, the set of action data may further define an interrelation among the tasks associated with the action. For instance, the action data may define chronological dependencies among the tasks associated with the action.

System 3 may automatically generate a plurality of task-specific data capture forms for each task associated with an action. Alternatively, analysts 8 may interact with system 3 to generate task-specific forms. The task-specific forms enable system 3 to capture task-specific contribution data relating to tasks associated with an action. Analysts 8 may generate the task-specific forms by, for example, selecting and customizing one or more templates from a library of templates. Furthermore, analysts 8 may define fields and other input mechanisms of the task-specific forms and tailor the task-specific forms for individual actions within enterprise 4. For example, analysts 8 may specify a set of action data that defines a recruitment action. In this example, the recruitment action may be associated with one or more tasks, such as an “ads approved” task, an “ads placed” task, an “interviewing starts” task, an “offers being made” task, and an “offers being accepted” task. Analysts 8 may also configure this set of action data to include one or more task-specific forms for each of the tasks associated with the recruitment action.

Analysts 8 may define temporal conditions among the tasks associated with an action. For example, analysts 8 may define the set of action data for an action to include a lead time between specific tasks associated with an action. In this example, the lead time may require that completion of a first task associated with the action occurs a certain amount of time prior to completion of a second task associated with the action. These interrelations may be “hard” or “soft,” where a “hard” interrelation requires a task to absolutely occur on time otherwise the entire action must be delayed, and where a “soft” interrelation yields more flexibility in that delays may push back the interrelated task but not delay the entire action.

After analysts 8 complete the modeling stage, system 3 enters the contribution stage. During the contribution stage a first set of contributors 6 interact with system 3 to input business-as-usual contribution data via a spreadsheet-like view. The business-as-usual contribution data is data related to ordinary business operations, such as the costs, income, net worth, and expenses associated with ordinary operation of enterprise 4. The first set of contributors 6 typically includes user who are skilled in business planning and that may provide central management of enterprise 4. For example, this first set of contributors may reside within a finance group of the enterprise that is familiar with the spreadsheet-like view as well as cost structures of enterprise 4. Once the first set of contributors 6 enters business-as-usual contribution data, system 3 may aggregate this business-as-usual contribution data. System 3 may then generate a business-as-usual forecast based on the aggregated business-as-usual contribution data.

Also during the contribution stage, a second set of contributors 6 may use the task-specific forms to input contribution data relating to specific tasks. The second set of contributors 6 may include those contributors 6 that are typically less skilled in enterprise financial planning. For example, this second set of contributors may include managers of departments or other units within the enterprise. Referring to the above recruitment action example, contributors 6 may, for example, update the status of the “ads approved” task, update an end date by which all interviews are to be completed before the “interviewing starts” task may begin, update a “number of job offers made” field of the “offers being made” task, update an “update a number of accepted offers”, and may update an “end date by which offers must be accepted for the offers being accepted” task. Once the second set of contributors 6 enters this task-specific contribution data, system 3 may validate the task-specific contribution data and provide feedback to contributors 6 concerning that validation. Validation may, for example, occur on the client-side through Java scripts, and other such client-side scripting languages. If system 3 successfully validates the task-specific contribution data, system 3 may aggregate the task-specific contribution data. System 3 may then generate an action-based forecast based on the aggregated task-specific contribution data.

After system 3 aggregates the task-specific contribution data, system 3 may combine the aggregated task-specific contribution data with the aggregated business-as-usual contribution data to form aggregated contribution data. The aggregated contribution data provides the basis for a composite forecast. The composite forecast may be viewed as a composite of two forecasts, the business-as-usual forecast overlaid with the action-based forecast. Subsequently, when one of contributors 6 or reviewers 7 modifies the task-specific contribution data, system 3 may automatically update the tasks according to their chronological dependencies, and may regenerate the composite forecast based on the modified task-specific contribution data.

While described herein with reference to a recruitment action requiring contributors 6 to participate in recruitment planning, system 3 may be used for other types of planning and performance management depending on the particular enterprise planning action being carried out within enterprise 4. For example, these types of planning and performance management may include financial forecasting, revenue forecasting, order forecasting, inventory forecasting, resource requirements estimation, and other types of planning and performance management. System 3 may also be used for other types of planning and performance management, including actions such as marketing campaigns, retail outlet launches, or any other business action. In each instance, analysts 8 may define actions that are associated with one or more tasks and interrelations among the tasks associated with the actions. Furthermore, analysts 8 may generate task-specific forms for each of the tasks. Contributors 6 may then use the task-specific forms to provide task-specific contribution data to system 3.

As described in further detail below, a client computing device allows contributors 6 to provide task-specific contribution data to system 3. The client computing device may provide one or more user interfaces that display the task-specific forms that contributors 6 may use to enter task-specific contribution data. The task-specific forms are “task-specific” in that they typically capture contribution data for only a single task in a manner that reflects the specific contribution data associated with that particular task. In this way, instead of interacting with a complex spreadsheet-like view that presents a multitude of options, contributors 6 may enter task-specific contribution data via a more user-friendly and narrowly defined task-specific form. Moreover, the task-specific forms facilitate delegation of data entry among various contributors, as discussed in detail below.

After contributors 6 enter the business-as-usual contribution data and the task-specific contribution data, system 3 may enter the reconciliation stage. During the reconciliation stage, system 3 may automate the review and reconciliation of the business-as-usual and task-specific contribution data with the corporate targets provided by analysts 8. For instance, system 3 may operate in accordance with the defined model to provide a hierarchical planning process having multiple reconciliation levels. As each of contributors 6 provides his or her contribution data, system 3 may automatically aggregate the business-as-usual and task-specific contribution data in real-time. This aggregated contribution data represents the business-as-usual forecast overlaid with the action-based forecast generated from the task-specific contribution data entered via the task-specific forms. System 3 may also allow reviewers 7 to access the aggregated contribution data associated with nodes of the organizational hierarchy that represent higher levels of enterprise 4. For example, upon receiving business-as-usual contribution data and task-specific contribution data from contributors 6, system 3 may identify all higher level nodes of the organizational hierarchy affected by the newly received contribution data. System 3 may then calculate new aggregate totals at each of the identified levels in real-time.

Reviewers 7 may view aggregated contribution data across enterprise 4 in real-time during the enterprise planning session. Reviewers 7 can then use the aggregated contribution data to determine whether to accept or reject changes to the task-specific contribution data attributable to various tasks that impact the task-specific contribution data.

System 3 may present the aggregated contribution data in a grid or spreadsheet-like view in conjunction with a task log. The task log may list one or more tasks that have impacts on a unit of the aggregated contribution data. Reviewers 7 may interact with the task log to selectively accept one or more tasks. In addition, reviewers 7 may use the task log to see what would happen to the aggregate contribution data if a task were not performed. Further, reviewers 7 may interact with the task log to roll-back, update, or roll-forward changes to a particular action. Reviewers 7 may, for example, defer a recruitment action to a later date, or reject the recruitment action entirely. Thus, the task log allows reviewers 7 to quickly view changes, roll-back changes, and roll-forward changes within the grid or spreadsheet-like view

The reconciliation stage continues until the aggregated contribution data is ultimately approved by the highest level of the organizational hierarchy, thereby ensuring that the contribution data from contributors 6 reconciles with corporate targets provided by analysts 8. Furthermore, during the reconciliation stage, one or more of reviewers 7 may be assigned the role of contributor and may enter contribution data during the review process using task-specific forms. For example, reviewers 7 may update tasks associated with the recruitment action in order to limit the number of new recruitments or defer recruitment of one or more new hires to a later data. Commonly, reviewers 7 do not simply reject or accept task-specific contribution data as it reflects the on-going needs and costs of enterprise 4, but instead defer or limit the application of resources to meet these needs and costs by updating the task-specific contribution data.

In this manner, system 3 may enable enterprise 4 to reconcile corporate models and organizational units with detailed forecasts, and to provide a platform that delivers collaborative, real-time planning and performance monitoring capabilities without requiring offline consolidation and aggregation of forecasts. The architecture of system 3 can readily scale to thousands of users. In addition, the action-based data management techniques of this disclosure may ease the use of complex planning software within large organizations by enabling users to interact with a simple, manageable, understandable, and task-specific front-end for system 3. The action-based data management techniques of the disclosure may offer the ability to order and/or customize an enterprise planning process by way of configuring one or more sets of action data. The action-based data management techniques of this disclosure may achieve additional advantages with respect to non-trivial and non-typical business tasks, instead of business-as-usual actions, because business-as-usual actions may not warrant the exacting type of attention that more unusual and complex non-trivial business actions require.

Furthermore, the action-based data management techniques of this disclosure may augment the conventional business-as-usual model, as described above. During entry of task-specific data and subsequent updates to previously defined task-specific data, system 3 may further reflect this entry or update of task-specific data in the composite forecast. Moreover, as soon as these atypical business actions reach a business-as-usual point, the action-based data management techniques may hand off these actions to the business-as-usual portion of the enterprise model, thereby providing a complete modeling of the entire transaction. In any case, action-based data management techniques may greatly simplify planning and management of business processes where complex multidimensional data must be captured and analyzed, but the processes are subject to unpredictable business actions.

As demonstrated below, the action-based data management techniques may be generally “friendlier” and less intimidating to a user than a grid-oriented interface for the entire planning and management process. In addition, the action-based data management techniques described herein may automatically update task-specific contribution data and aggregated contribution data within the underlying multidimensional data so as to reflect changes to a specific action. For example, system 3 may automatically update the multidimensional data within one or more data cubes based on captured task-specific information and the interrelations defined within the set of action data. This may allow users to avoid complicated procedures otherwise required by conventional enterprise planning and management systems in response to a delay of a task. Such systems, for example, may force the user(s) to reenter and/or to rearrange planning data using a grid interface, which may be difficult.

Enterprise users (e.g., contributors 6, reviewers 7, and analysts 8) may use a variety of computing devices to interact with system 3 via network 9. For example, an enterprise user may interact with system 3 using a laptop computer, desktop computer, or the like, running a web browser, such as Internet Explorer™ from Microsoft Corporation of Redmond, Wash. Alternatively, an enterprise user may use a personal digital assistant (PDA), such as a Palm™ organizer from Palm Inc. of Santa Clara, Calif., a web-enabled cellular phone, or similar mobile handheld device. Network 9 may be any type of communication network, such as a packet-based digital network like the Internet. In this manner, system 2 can readily scale to suit large enterprises. The enterprise users may directly access system 3 via a local area network, or may remotely access system 3 via a virtual private network, remote dial-up, or similar remote access communication mechanism.

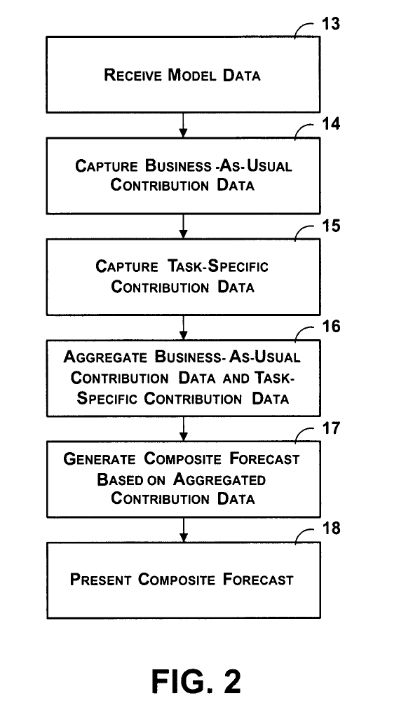

FIG. 2 is a flowchart illustrating an exemplary operation of system 3. In this exemplary operation, system 3 receives model data from analysts 8 (13). The model data may define an enterprise planning model for use within a subsequent enterprise planning session. Furthermore, the model data may comprise action data that specifies one or more tasks. In addition, the model data may define a plurality of task-specific forms to capture task-specific contribution data for the enterprise planning session on a per-task basis. The model data may also define a mapping for storing the task-specific contribution data within a multidimensional dataset.

After receiving the model data, system 3 may capture business-as-usual contribution data from a first set of contributors 6 (14). Business-as-usual contribution data is data associated with ordinary operations of enterprise 4. Next, system 3 may capture task-specific contribution data from a second set of contributors 6 using the task-specific forms (15). The task-specific contribution data is associated with out-of-the-ordinary operations of enterprise 4. When system 3 captures the task-specific contribution data, system 3 may store the task-specific contribution data in the multidimensional dataset in accordance with the mapping. After system 3 captures the task-specific contribution data, system 3 may aggregate the captured business-as-usual contribution data and the task-specific contribution data in order to form aggregate contribution data for the enterprise planning session (16). As discussed in detail below, system 3 may use user-specified overlay calculations to aggregate the captured business-as-usual contribution data and the captured task-specific contribution data.

Next, system 3 may generate a composite forecast based on the aggregate contribution data (17). System 3 may then present this composite forecast on a user interface (18). In a first example, system 3 may automatically generate a web page that specifies the composite forecast. In this example, system 3 may then provide the web page to a web browser that presents the web page to an enterprise user. In a second example, system 3 may transmit the composite forecast to a special-purpose software application that presents the composite forecast to an enterprise user.

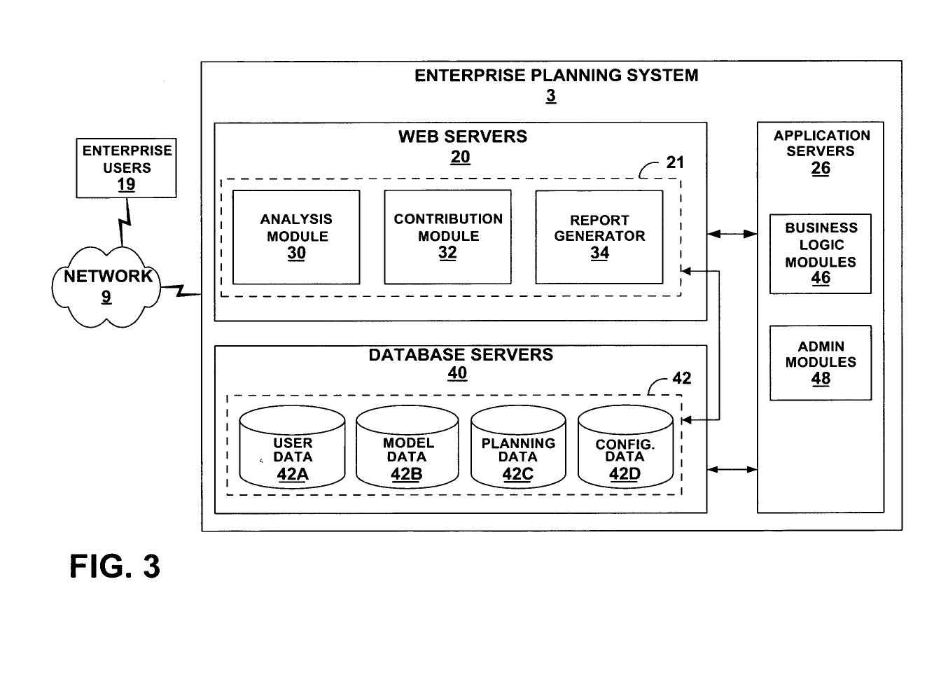

FIG. 3 is a block diagram illustrating exemplary details of system 3. In the example of FIG. 3, system 3 includes a set of one or more web servers 20, a set of one or more application servers 26, and a set of one or more database servers 40.

Web servers 20 provide an interface for communicating with enterprise users 19 via network 9. Web servers 20 execute web server software, such as Internet Information Server™ from Microsoft Corporation, of Redmond, Wash.

In addition to the web server software, web servers 20 may execute software modules 21. Software modules 21 may comprise Lotus scripts, Java scripts, Java Applets, Active Server Pages, web pages written in hypertext markup language (HTML) or dynamic HTML, Active X objects, and other suitable modules. Web servers 20 serve up web pages defined by software modules 21, and communicate the web pages to computing devices of enterprise users 19. The web pages may include static media, such as text and graphic imagery, as well as conventional input media such as text entry boxes, radio buttons, drop-down menus and the like, for receiving information from enterprise users 19.

Software modules 21 interact with database servers 40 to access enterprise data 42. Enterprise data 42 may be stored in a number of different forms including one or more data storage files, or one or more database management systems executing on one or more of database servers 40. The database management systems may be relational database management systems, hierarchical database management systems, multidimensional database management systems, object oriented database management systems, object-relational database management systems, or other types of data management systems.

In the example of FIG. 3, enterprise data 42 includes user data 42A, model data 42B, planning data 42C, and configuration data 42D (“CONFIG. DATA”). Although illustrated separately, user data 42A, model data 42B, planning data 42C, and configuration data 42D may be stored as single database or other data storage structure. For example, user data 42A, model data 42B, planning data 42C, and configuration data 42D may stored in a single relational database.

User data 42A stores information regarding each of users 19. For example, user data 42A may store a name, email address, and other contact information for each of users 19. Model data 42B stores enterprise planning models defined by analysts 8. For example, model data 42B may store information that defines a reconciliation process developed by analysts 8, including the number of reconciliation levels, the various nodes in the organizational hierarchy, and data that indicates which ones of contributors 6 are associated with each node. In addition, model data 42B stores sets of action data, including the task-specific forms corresponding to tasks and the interrelationships among the tasks. Planning data 42C may store one or more multidimensional datasets that store business-as-usual contribution data, task-specific contribution data, actual contribution data, aggregated contribution data, and potentially other types of planning data for each of the nodes of the organizational hierarchy. Configuration data 42D stores basic configuration data for system 3.

Application servers 26 provide an operating environment for execution of business logic modules 46. Business logic modules 46 provide functionality for accessing and processing enterprise data 42 in response to requests from software modules 21. For instance, business logic modules 46 may comprise software routines that, when invoked by software modules 21, cause one or more of application servers 26 to perform enterprise planning functions. Application servers 26 may also provide an operating environment for execution of administration modules 48. Administration modules 48 may comprise software routines that cause one or more of application servers 26 to perform various administrative tasks within system 3.

In the example of FIG. 3, software modules 21 include an analysis module 30, a contribution module 32, and a report generator 34. Analysis module 30 may include one or more software modules for creating enterprise planning models. Analysis module 30 allows analysts 8 to define actions, tasks associated with actions, the interrelation or chronological dependencies among those tasks, and to assign corresponding ones of users 19 as owners of actions. In addition, analysts 8 may use analysis module 30 to define task-specific forms for collecting task-specific contribution data. Model data 42B maps the task-specific contribution data into one or more multidimensional datasets of planning data 42C. For example, planning data 42C may include a data cube that has three dimensions: a time dimension, a variable dimension, and a forecast dimension. As used in this disclosure, a “variable” is type of enterprise data. In this example, a task-specific form may be used to capture task-specific contribution data related to an advertisement task that occurs during January 2007 and that has a financial impact on an “Advertising” variable. The captured task-specific contribution data may be mapped to cells of the data cube associated with the “task-specific contribution data” item of the forecast dimension, that are also associated with the “January 2007” item of the time dimension, and that are also associated with the “Advertising” item in the financial variable dimension.

Analysis module 30 also allows analysts 8 to define one or more mechanisms that automate the entry of task-specific contribution data or ensure that contributors 6 submit task-specific contribution data in a timely manner. For example, analysts 8 may use analysis module 30 to define a software module that interacts with a software application, such as Microsoft Outlook. In this example, a software module may cause the software application to issue reminders (e.g., electronic mail messages, to-do items, etc.) to users 19 pertaining to the tasks.

Contribution module 32 may include one or more software modules that present the task-specific forms to contributors 6, that capture task-specific contribution data from contributors 6, that aggregate the contribution data, and that provide access to a composite forecast based on the aggregated contribution data. In one embodiment, contribution module 32 includes software modules that present the task-specific forms to contributors 6 via a series of customized planning windows. In other embodiments, client-side software modules present the task-specific forms. As contributors 6 provide contribution data, contribution module 32 may automatically update the contribution data in real-time, and present a composite forecast based on the contributors' responses. For instance, contribution module 32 may update planning data 42C to reflect changes to the contribution data.

Contribution module 32 may display the composite forecast using a screen that shows both a grid and a task log. The task log may list tasks that have impacts on the composite data. Reviewers 7 may interact with this screen to selectively accept or reject one or more of the sequential plurality of pending changes. Moreover, reviewers 7 may interact with this screen to roll-back the impacts of a pending task, whereby report generator 34 removes the impacts of the task from the grid. Reviewers 7 may also interact with this screen to roll-forward the most recently removed pending change, whereby contribution module 32 adds the impacts of one or more of the tasks to the grid. Through these roll-forward and roll-back operations reviewers 7 may view, step-by-step, the impacts of individual tasks on the grid prior to deciding to accept or to reject those tasks.

Report generator 34 may include one or more software modules that generate enterprise planning reports based on the aggregated contribution data received from contributors 6 and stored within planning data 42C. For example, report generator 34 may allow users 19 to formulate complex queries for generating reports and performing other data analysis functions on enterprise data 42. Report generator 34 may be a web-oriented software module that generate web pages, may be a stand-alone executable program, or may be another type of software module.

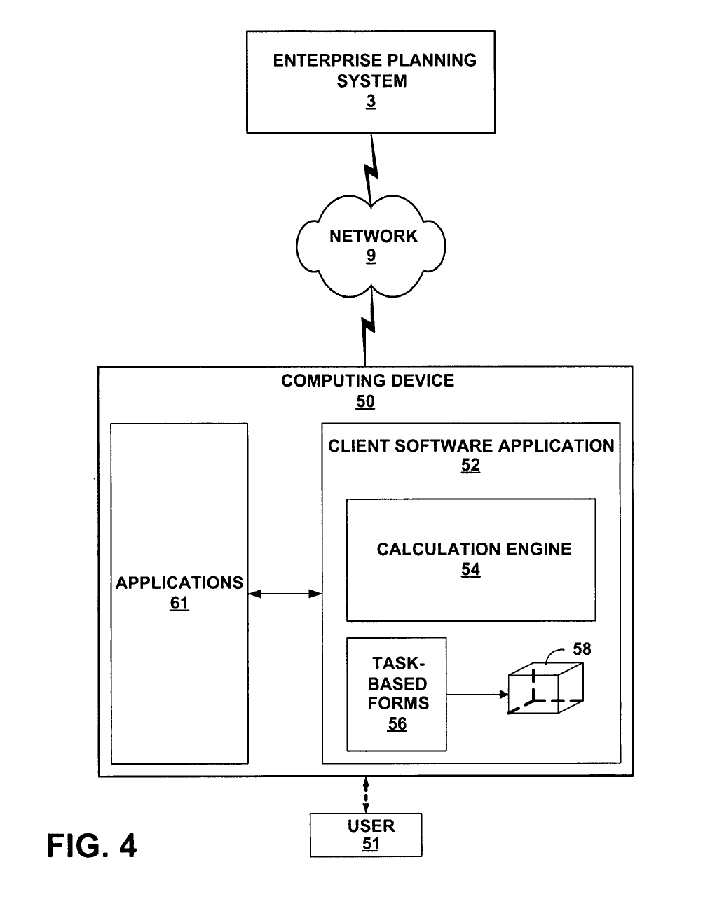

FIG. 4 is a block diagram illustrating an exemplary computing device 50, including various software modules executing thereon, when operated by a user 51. In the example of FIG. 4, user 51 may be one of contributors 6 or one of reviewers 7.

As illustrated in the example of FIG. 4, computing device 50 includes a client software application 52. Client software application 52 may be a web browser, a specialized spreadsheet application, or another type of software application. When user 51 wants to interact with system 3, user 51 may instruct client software application 52 to access system 3. In response to such instruction from user 51, client software application 52 may cause computing device 50 to download and to install a calculation engine 54 and a set of task-specific forms 56 from system 3. After computing device 50 downloads calculation engine 54 and task-based forms 56, client software application 52 may install calculation engine 54 and task-based forms 56 in client software application 52. Alternatively, calculation engine 54 and task-specific forms 56 may be previously installed on computing device 50.

In some implementations, system 3 may utilize a “cut-down” process by which the multidimensional dataset in planning data 42C is “sliced” for each user 19 in accordance with the defined enterprise model. During this cut-down process, system 3 may identify areas of the model defined in model data 42B to which user 51 is assigned, either as a contributor or as a reviewer. After identifying the area of the model to which user 51 is assigned, system 3 may extract (i.e., “slice”) the data in identified area of the model. When user 51 instructs client software application 52 to access system 3 in a “rich-client” architecture system 3 may communicate the extracted data to computing device 50. When computing device 50 receives the extracted data, computing device 50 may store the extracted data in a data store 58. In this fashion, system 3 need not communicate the entire model to each of users 19, thereby reducing communication time as well as resource requirements. Instead, each one of users 19 only receives data relevant to their respective portions of the planning process.

User 51 may use client software 52 to interact with task-specific forms 56 in order to input task-specific contribution data. Task-specific forms 56 may receive the task-specific contribution data and store the task-specific contribution data to data store 58. When user 51 inputs task-specific contribution data using task-specific forms 56, calculation engine 54 may recalculate aggregate task-specific contribution data. Calculation engine 54 may then aggregate the recalculated aggregate task-specific contribution data and the business-as-usual contribution data in data store 58 to form an updated set of aggregate contribution data. User 51 may also view a composite forecast based on the updated set of aggregate contribution data. In this way, user 51 may view the effects of inputting particular task-specific contribution data. Because calculation engine 54 is resident within client software application 52, the updated task-specific contribution data do not have to be resubmitted to system 3 in order for user 51 to view the composite forecast based on the updated set of aggregate contribution data.

If user 51 wishes to end the planning session, but has not finished inputting task-specific contribution data, user 51 may save the task-specific contribution data already entered into task-specific forms 56 to data store 58, and/or save the task-specific contribution data already entered into task-specific forms 56 back to system 3. Subsequently, when user 51 wishes to continue with an action-based data management process, user 51 may direct client software application 52 to access data store 58 or system 3, at which time client software application 52 loads the appropriate task-specific forms 56 and data store 58 for further editing. When user 51 finishes entering task-specific contribution data into task-specific forms 56, user 51 may submit the task-specific contribution data to system 3. When user 51 submits the task-specific contribution data, system 3 may integrate the submitted task-specific contribution data into planning data 42C, where it may be viewed by reviewers 7 and/or analysts 8 associated with higher nodes of the organizational hierarchy. In this way, user 51 may have the ability to save work locally, to work offline, or to finish entering task-specific contribution data into task-specific forms 56 at a later time, as well as save work to system 3, if desired.

In similar fashion, reviewers 7 may interact with enterprise systems 3 via client software application 52. Reviewers 7 may use the task log or some other method to review, reject, or accept the task-specific contribution data in view of corporate targets provided by analysts 8. This process of accepting and rejecting task-specific contribution data continues until ones of reviewers 7 associated with the highest level of the organizational hierarchy accept the task-specific contribution data. In this way, system 3 may ensure that the task-specific contribution data from contributors 6 reconciles with corporate targets.

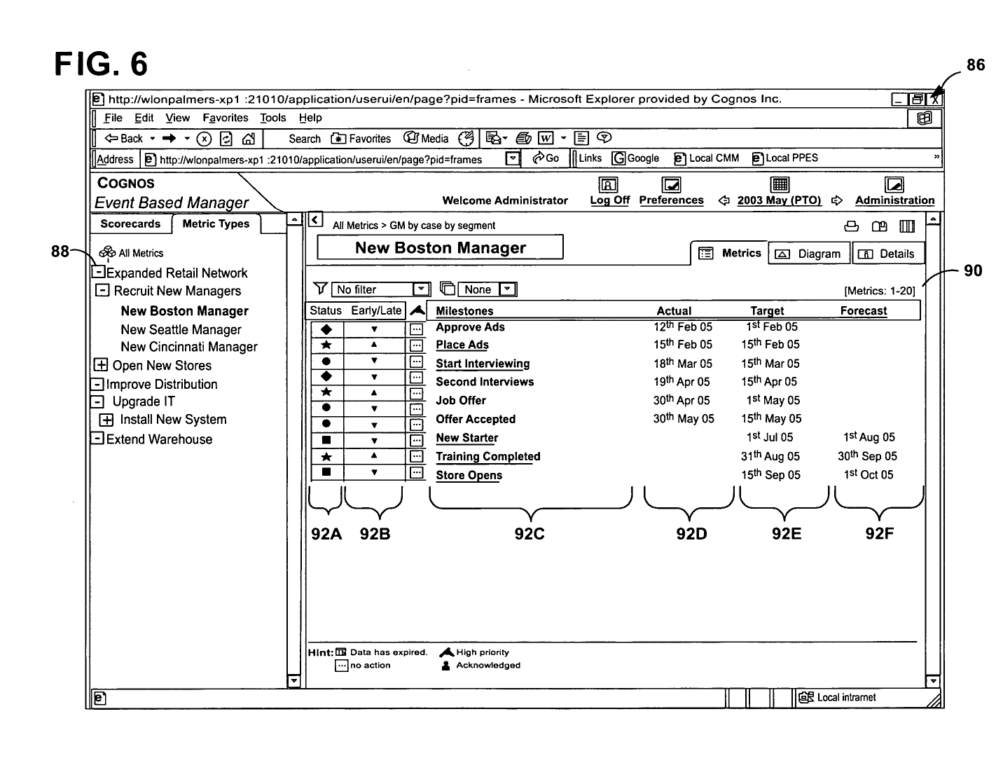

Furthermore, in the example of FIG. 4, computing device 50 includes software applications 61. Software applications 61 may, for example, include word processor applications, work management applications, email applications (e.g., Microsoft Outlook), and other software applications. As described below with regard to FIG. 6, client software application 52 may interact with software applications 61 in order to provide alerts regarding tasks associated with user 51.

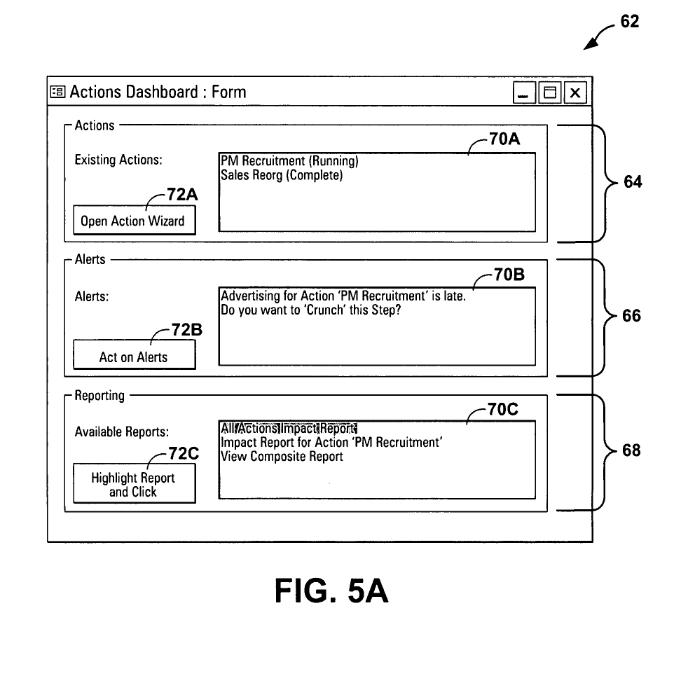

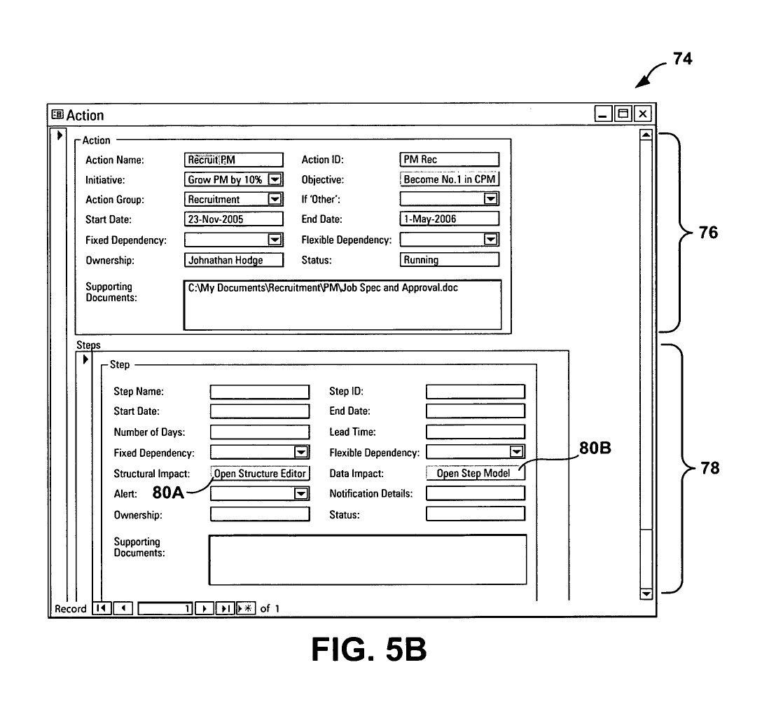

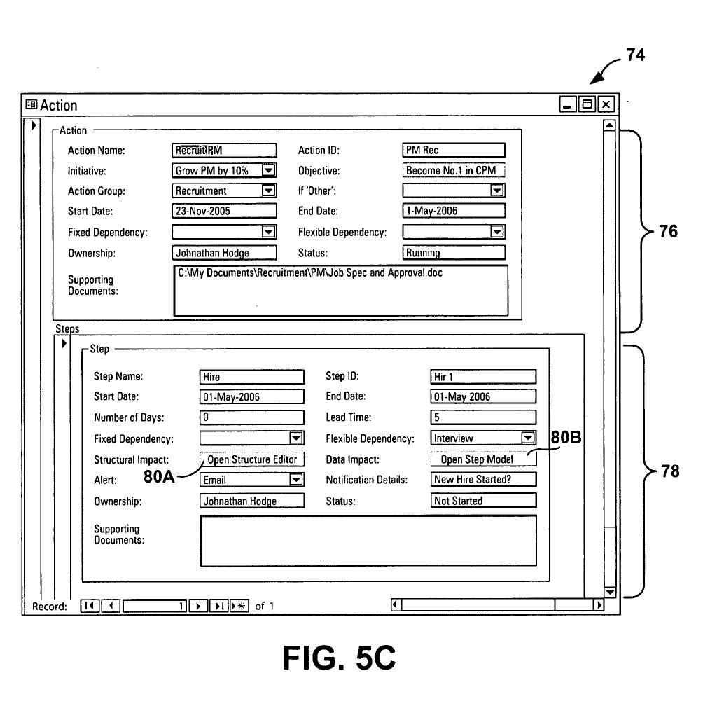

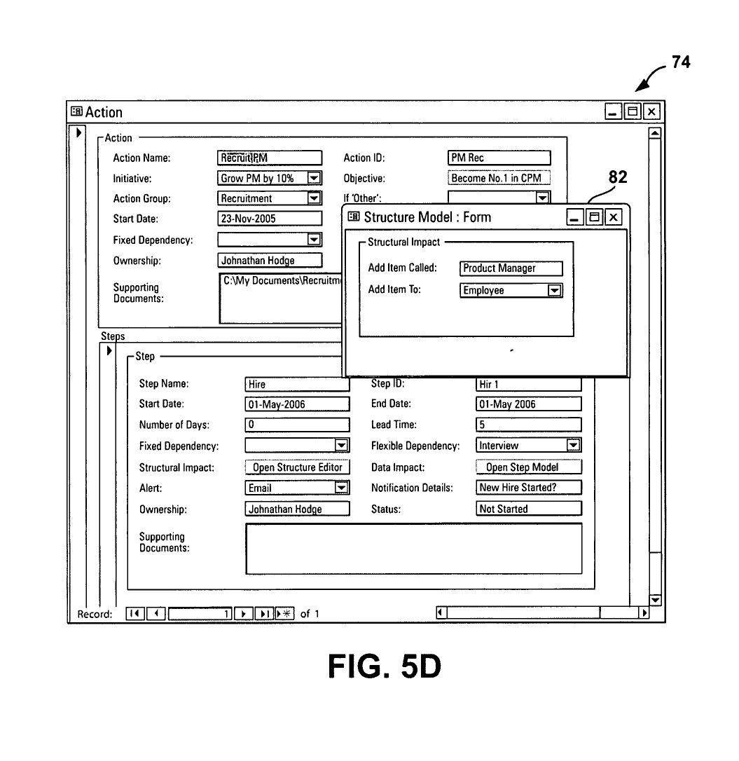

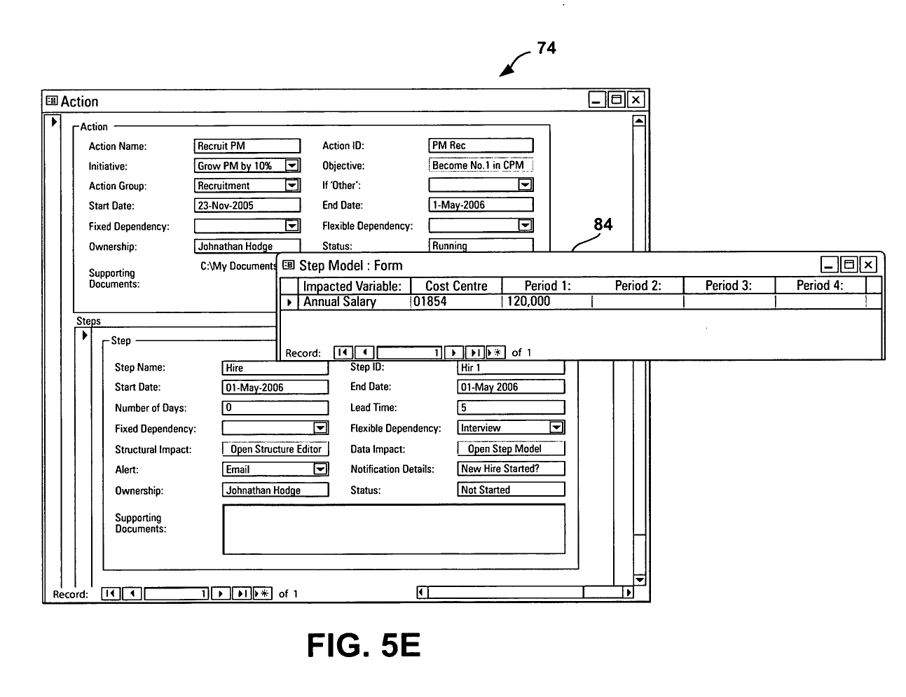

FIGS. 5A-5E show screenshots of exemplary user interfaces presented by computing device 50. FIG. 5A shows a screenshot of an exemplary user interface 62 presented by computing device 50. Computing device 50 may present several windows or pages. Computing device 50 uses a set of action forms to capture action data, data defining one or more tasks, and data defining the interrelation among the tasks via a set of action forms. As one example, user interface 62 includes an actions window 64, an alerts window 66, and a reporting window 68, by which analysts 8 may define an action.

In the example of FIG. 5A, actions window 64 includes an existing actions field 70A and an Open Action Wizard button 72A. Existing actions field 70A contains a list of currently defined actions. For example, as shown in FIG. 5A, existing actions field 70A contains a “PM recruitment” action and a “Sales Reorg” action. Existing actions field 70A may also show the current status of each action in the list of currently defined actions, e.g., running or complete. When selected, button 72A causes planning system 3 to open another user interface by which analysts 8 may define a new action. Upon selecting button 72A, system 3 presents another user interface 74, which is described below in reference to FIG. 5B. This new user interface is commonly called a “wizard,” hence the “Open Action Wizard” text displayed on button 72A.

Alerts window 66 includes an “existing alerts” field 70B and a button 72B. “Existing alerts” field 70B contains a list of currently defined alerts. For example, as shown in FIG. 5A, “existing alerts” field 70B contains an “Advertising for Action ‘PM Recruitment’ is Late” alert and a “Do you want to ‘Crunch’ this Step?” alert. When selected, button 72B causes planning system 3 to open a user interface by which users 19 may act on alerts.

Reporting window 68 includes an “available reports” field 70C and a button 72C. “Available reports” field 70C contains a list of available reports that report generator 34 has previously generated. For example, as shown in FIG. 5A, “available reports” field 70C contains the reports “All Actions Impact Report,” “Impact Report for Action ‘PM Recruitment,’” and “View Composite Report.” When selected, button 72C causes system 3 to open another user interface by which user 51 may view the selected report.

While described herein as containing fields 70A-70C and buttons 72A-72C, system 3 may present other display and input mechanisms for displaying existing actions, alerts, and reports, and opening subsequent user interfaces. Exemplary display mechanisms include dropdown lists and text boxes, and exemplary input mechanisms include checkboxes, radio buttons, and switches.

FIG. 5B shows a screenshot of an exemplary user interface 74 presented by computing device 50 when user 51 selects button 72A of user interface 62. User interface 74 includes an action form 76 and a step form 78. In this context, the term “step” is synonymous with the term “task.” User 51 may define a new action, i.e., create new set of action data in action form 76 and define tasks associated with the new action in task-specific form 78.

As shown in FIG. 5B, action form 76 may include a number of fields, dropdown lists, and other selection and/or input mechanisms for specifying action data. As illustrated in the example of FIG. 5B, action form 76 may include an action name field, an initiative dropdown list, an action group dropdown list, a start date field, a fixed dependency dropdown list, an ownership field, an action ID field, an objective field, an “If ‘Other’” field, an end date field, a flexible dependency dropdown list, a status field, and a supporting documents field. The action name field allows user 51 to enter a name for the particular action. The initiative dropdown list allows user 51 to select an initiative to which the action seeks to satisfy. The action group dropdown list allows user 51 to select an action group, such as the recruitment action group, to which the given action belongs. The start date field allows user 51 to enter a start date on which the newly defined action should begin. The fixed dependency dropdown list allows user 51 to specify a “hard” interrelation to another action within the action group. The ownership field allows user 51 to specify an owner of the particular action. The action ID field allows user 51 to specify a unique action identifier by which system 3 may identify the newly created “recruit PM” action. The objective field allows user 51 to enter an objective, such as “Become No. 1 in CPM” objective shown in FIG. 5B. The “If ‘Other’” field allows user 51 to specify an objective not presented within the objective field. The end date field allows user 51 to specify an end date by which the action should be completed. The flexible dependency field allows user 51 to specify a “soft” interrelation, which is described above. Finally, the supporting documents field allows user 51 to link a particular document, e.g., “C:\My Documents\Recruitment\PM Job Spec and Approval.doc” as shown in FIG. 5B, to the newly specified “Recruit PM” action.

Task-specific form 78 may also include a number of fields, dropdown lists, and other selection and/or input mechanisms for specifying task data. For example, task-specific form 78 may include those fields and input mechanisms shown in FIG. 5B, such as a step name field, a start date field, a number of days field, a fixed dependency field, a structural impact button 80A, an alert dropdown list, an ownership field, a step 1D field, an end date field, a lead time field, a flexible dependency dropdown list, a data impact button 80B, a notification details field, a status field, and a supporting documents field. User 51 may specify each of these fields and select each of buttons 80A, 80B in order to define a task and indicate an interrelation among a plurality of tasks. In this example, the step name field allows user 51 to specify a name for a new task. The start date field allows user 51 to specify a start date by which the task should begin. The “number of days” field allows user 51 to specify a number of days to complete the task. The fixed dependency dropdown list allows user 51 to specify a “hard” interrelation, which is described above, with another task. Structural impact button 80A allows user 51 to open another user interface by which user 51 may enter a structural impact. A structural impact of a task is a change to the structure of a multidimensional dataset in planning data 42C. For instance, the structural impact of a task may be the addition of an item along a dimension of a multidimensional data cube in planning data 42C. The alert dropdown list allows user 51 to link an alert from the dropdown list to the given task. The ownership field allows user 51 to assign ownership of this task to one of users 19, thereby enabling the delegation of task data entry into the composite forecast. The step 1D field allows user 51 to specify a unique name by which system 3 may identify a particular task. The end date field allows user 51 to specify an end date by which the task should be completed. The lead time field allows user 51 to specify a lead time by which this task should be finished before any flexibly dependent tasks may begin. The flexible dependency dropdown lists allows user 51 to select a “soft” interrelation between this task and another task. Data impact button 80B allows user 51 to open another user interface by which user 51 may enter a data impact. A data impact of a task is the impact of the task on data that exists within planning data 42C. The notification details field allows user 51 to define details concerning the alert. The status field allows user 51 to indicate a status for this task. Finally, the supporting documents field allows user 51 to link a particular document to this task.

FIG. 5C shows exemplary user interface 74 from FIG. 5B, where user 51 populated the fields of task-specific form 78. As shown in FIG. 5C, user 51 entered a step name “Hire” in the step name field, entered a start date of “01-May-2006” in the start date field, entered a “0” number of days in the number of days field, selected an “email” alert from the alert dropdown list, entered “Jonathan Hodge” in the ownership field, entered “Hir1” in the action ID field, entered an end date of “01-May-2006” in the end date field, entered a lead time of “5” in the lead time field, selected a soft relationship between this hire task and the interview task from the flexible dependency dropdown list, entered a notification detail of “New Hire Started?” in the notification details field, and entered a “Not Started” status in the status field.

In entering this task data via task-specific form 78, user 51 may associate the entered task with the particular action. In the illustrated instance, user 51 is associating the “Hire” task with the “Recruit PM” action. By specifying the flexible dependency, user 51 may cause system 3 to add another interrelation among the tasks associated with the set of action data. As shown below with respect to FIGS. 5D, 5E, user 51 may define additional interrelations, such as structural impact and data impact, between the newly defined task and the business-as-usual contribution data.

FIG. 5D shows exemplary user interface 74 from FIG. 5C with the resulting user interface 82 being imposed on top of user interface 74 after user 51 selects structural impact button 80A. Structural model user interface 82 includes an “add item called” field and an “add item to” dropdown list. The “add item called” field allows user 51 to enter an item name. The “add item to” dropdown list allows user 51 to select a dimension of a multidimensional dataset in data store 58. After user 51 enters an item name in the “add item called” field and selects a dimension from the “add item to” dropdown list, system 3 may add an item of the item name to the selected dimension of the multidimensional dataset.

In the example of FIG. 5D, user 51 has entered the item name “Product Manager” in the “add item called” field and has selected the “Employee” dimension in the “add item to” dropdown list. Thus, system 3 may add an item “Product Manager” to the “Employee” dimension of a multidimensional dataset in data store 58. This may appropriate in a scenario in which the “Employee” dimension has items associated with employees of enterprise 4. In this scenario, it is appropriate to add a new item to the “Employee” dimension when a new employee is hired.

FIG. 5E shows exemplary user interface 74 from FIG. 5C with the resulting step model user interface 84 being imposed on top of interface 74 after user 51 selects data impact button 80B. Step model user interface 84 includes an abbreviated spreadsheet type form that enables user 51 to specify an impacted variable, a cost centre, and periods 1-4. As shown in FIG. 5E, user 51 has entered an impacted variable called “Annual Salary,” a cost centre identified by number “01854,” and a period 1 number of “120,000.” By entering this data, user 51 specifies that the new “Hire” task will impact the annual salary at the specified cost centre by increasing the annual salary for period 1 by $120,000. Thus, upon completion of this task, i.e., after hiring a new project manager, the impact to annual salary will occur accordingly. When user 51 enters this data, calculation engine 54 may store the value $120,000 in a cell associated with the “Product manager” item of the “Employee” dimension, the “Annual Salary” item of the “Variable” dimension, the “01854” item of the “Cost Centre” dimension, and the “Period 1” item of a “Time” dimension of a multidimensional dataset in data store 58.

System 3 may present task-specific forms, such as task-specific form 78, during a subsequent planning process in order to provide contributors 6 with a more convenient and practical way of entering action data into model data 42B and task-specific contribution data into planning data 42C. That is, contributors 6 may enter task-specific contribution data on a per-task basis, and system 3 automatically resolves any impact on data relating to other tasks. During the subsequent planning process, rather than working with a grid or spreadsheet of numbers concerning the enterprise as a whole, a contributor may input contribution data through much more easily managed user interfaces.

FIG. 6 shows another exemplary user interface 86 presented by client software application 52 of FIG. 4. In the example of FIG. 6, client software application 52 displays a web page generated by system 3. This web page constitutes user interface 86. Typically, client software application 52 presents user interface 86 to user 51 after user 51 logs into system 3. System 3 may generate user interface 84 such that user interface 84 reflects data associated with a node of the organizational hierarchy associated with user 51. For example, user 51 may be assigned to the “North American Region” node in the organizational hierarchy. In this example, when user 51 logs into system 3, system 3 may generate user interface 86 such that user interface 84 includes components specific to the “North American Region” node in the organizational hierarchy. For instance, system 3 may identify tasks that correspond to the “North American Region” node (e.g., the hire task described above in reference to FIG. 5D) and generate user interface 86 such that user interface 86 includes the identified tasks in user interface 86. In this way, by associating user 51 with the “North American Region” node, analysts 8 effectively delegate to user 51 the entry of task-specific contribution data pertaining to tasks associated with the “North American Region” node.

In the example of FIG. 6, user interface 86 comprises an action window 88 and a task management window 90. Action window 88 comprises a list of actions, some of which belong to action groups. As illustrated in the example of FIG. 6, action window 88 specifies an “Expand Retail Network” action group that includes “Recruit New Managers” action group. The “Recruit New Managers” action group includes a “New Boston Manager” action, a “New Seattle Manager” action, and a “New Cincinnati Manager” action. Actions displayed in bold print, such as the “New Boston Manager” action, indicate that user 51 selected that action. Once user 51 selects an action, task management window 90 displays tasks relating to the selected action. Thus, as shown in the example of FIG. 6, task management window 90 presents tasks corresponding to the “New Boston Manager” action.

Task management window 90 includes columns that display information relevant to particular tasks. As illustrated in the example of FIG. 6, task management window 90 includes a status column 92A, an early/late column 92B, a “milestone” or task description column 92C, an actual date column 92D, a target date column 92E, and a forecast date column 92F. Status column 92A indicates via graphical representations the status of a task defined in each row of the table. Early/late column 92B indicates via graphical representations whether the task defined in each row will be completed either early or late. Task description column 92C indicates the name assigned to the task during creation of that task. Actual date column 92D indicates the actual date by which the task was completed. Target date 92E indicates the target date specified during the creation of the task, e.g., in the end date field, for each task. Forecast date 92F indicates a forecasted date for each task of the rows, where system 3 determines the forecast date from the “hard” and “soft” interrelations specified during creation of the task, e.g., in the fixed dependency and flexible dependency dropdown lists.

User 51 may interact with task management window 90 to view a particular task, such as the “Place Ads” task. User 51 may select a task from task description column 92C so as to view the configuration of the selected task. Upon selecting a task, system 3 may present another user interface that includes the task-specific form corresponding to the selected task, such as user interface 74 of FIG. 5C that includes task-specific form 78. User 19 may update, alter, edit, or delete the task via the corresponding task-specific form. Once user 19 performs one of these operations, system 3 may update, in real-time, other tasks interrelated to the tasks upon which user 51 performed the operations. Subsequently, user 51 may return to user interface 86 in order to view the effects of such operations upon the actions as a whole.

For example, user 51 may edit the “Place Ads” task shown in task description column 92C. The “Place Ads” task may interrelate with the “Start Interviewing” task via a flexible dependency, or “soft” interrelation, requiring a lead time of one month from completion of the “Place Ads” task prior to the start of the “Start Interviewing” task. User 51 may alter this end date of the “Place Ads” task via the end-date field of another user interface that includes a task-specific form corresponding to the “Place Ads” task. Upon altering the end date and returning to user interface 86, system 3 may update the interrelated “Start Interviewing” task by accelerating or pushing the actual date, shown in actual date column 92D, that corresponds to the “Start Interviewing” task depending upon whether user 51 altered the end date such that the end date occurs earlier or later in time, respectively. System 3 may also update the actual date corresponding to the “Place Ads” task accordingly. Further, system 3 may update any other tasks shown in task description column 92C according to their interrelations with either of the “Place Ads” task or the “Start Interviewing” task.

In addition, system 3 may, in some embodiments, query user 51 to determine whether user 51 has performed all actions to which user 51 was assigned as the owner. This query may be configured to occur at specified times according to a schedule, e.g., at the end of every month, quarter, or year, or in response to an event. Typically, system 3 presents a user interface that displays all actions to which user 19 was assigned as the owner. User 51 may use dropdown lists, check boxes, or other input mechanisms within the user interface to indicate which actions were performed. In response to this selection, report generator 34 in system 3 may automatically generate commentary on the difference between actual data and forecasted data based on the indication. Report generator 34 may also automatically generate accrual data on the difference between the actual and forecasted data based on the indication.

Contribution module 32 may perform the above described operations. Contribution module 32 may, for example, access model data 42B to determine which actions user 51 owns. Next, contribution module 32 may present the user interface through which user 51 may indicate whether the actions owned by user 51 have been performed. User 51 indicates which actions have been performed, whereupon contribution module 32 may specify within planning data 42C those actions that were indicated. Contribution module 32 may next automatically cause report generator 34 to prepare commentary and accrual data on the difference between the actual data and forecasted data for each of those actions owned by user 51. Thus, system 3 may automate certain portions of report generation so as to reduce the complexity of record keeping.

In this manner, system 3 may allow user 19 to easily manage numerous interrelated tasks despite changing conditions without having to interact with grid- or spreadsheet-like views. Moreover, because system 3 allows users 19 to define interrelations among the tasks and store those interrelations within a set of action data, system 3 can automatically adjust all tasks according to their interrelations among each other. For example, users 19 need not remember such interrelations or move, update, or alter numerous numbers within a grid or spreadsheet-like view of numbers in instances where delays push a task forward in time.

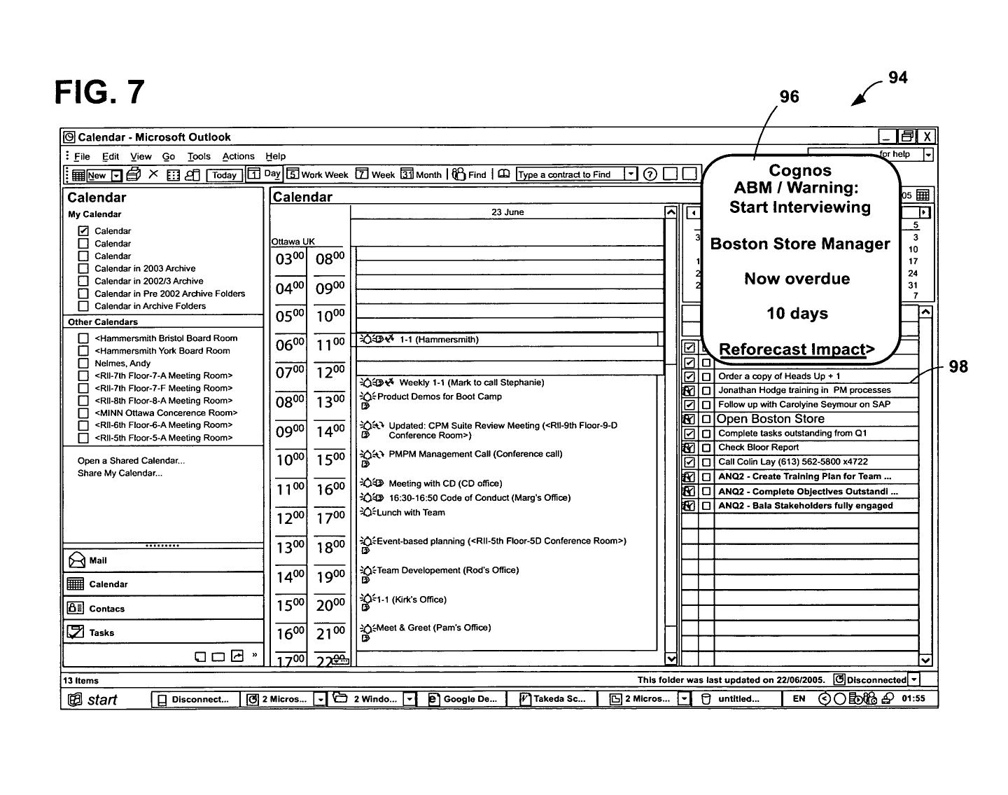

FIG. 7 shows another screenshot of an exemplary software application 94, where system 3 interacts with software application 94 to present an alert window 96. As shown in the example of FIG. 7, software application 94 comprises the Microsoft Outlook application, which is an email and calendar application created by Microsoft Corporation of Redmond, Wash. and frequently used to view and create email, organize tasks within a calendar format, as well as, maintain and create notes, contacts, and email lists. Software application 94 may be one of applications 61 of FIG. 4, where applications 61 communicate with system 3 via client software 52.

System 3 may synchronize or “synch” with software application 94, such that system 3 may insert tasks and reminders into software application 94. Users 19 may define alert 96 within an alert field of a task-specific form, as described above. Software application 94 may receive these tasks and/or alerts and display them via a task sidebar 98 of software application 94. As shown in task sidebar 98, system 3 has synched an “Open Boston Store” action group into software application 94. Software application 94 typically keeps track of these alerts and, upon the passing of critical times and/or dates pertaining to the alerts, notifies user 51 of pertinent developments concerning the alert via alert window 96. In this respect, system 3 facilitates management of currently defined actions, and forms the basis of “performance management” language of its name.

Alert window 96 shows an exemplary alert that corresponds to the “Open Boston Store” action, which may be highlighted within task sidebar 98. The exemplary alert indicates that there is an “ABM Warning,” or action-based management warning detailing that the “Start Interviewing” task of the “Boston Store Manager” action (which is included within the “Open Boston Store” action group) is now overdue by 10 days. Alert window 96 also presents a convenient link that causes system 3 to present a user interface to “Reforecast Impact” associated with the delay of 10 days.

Through this synching of tasks and/or alerts, system 3 may apprise user 51 of pertinent developments concerning tasks assigned to user 51. Although described in reference to Microsoft Outlook alerts, other forms of alert notification, such as email, may apply equally to the invention described herein, and the invention is not be limited to the described form of alert notification.

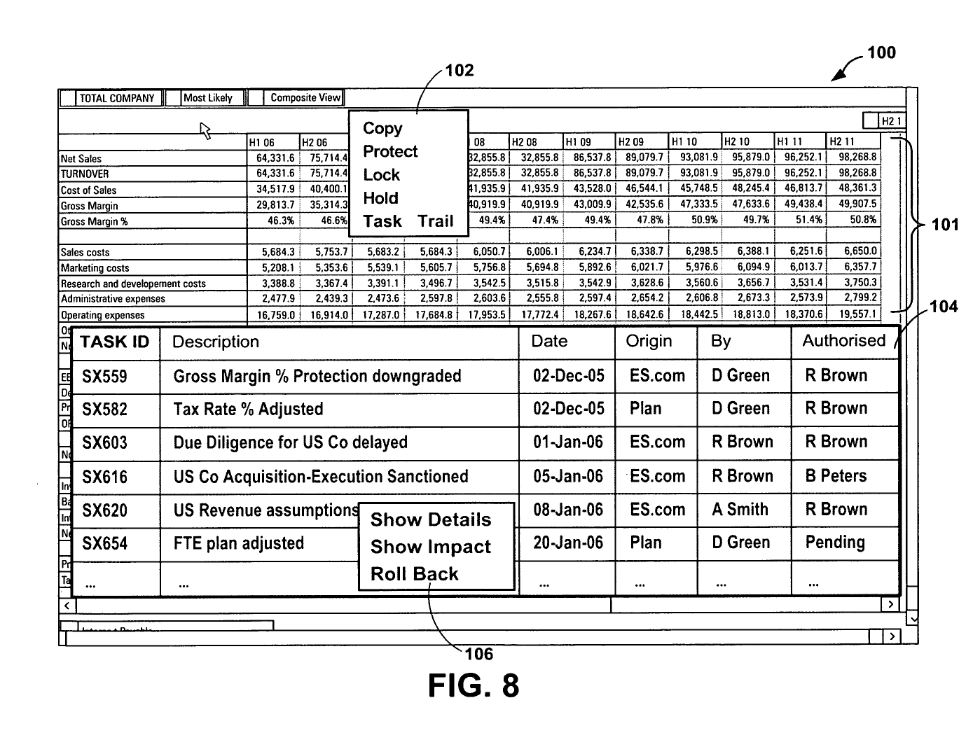

FIG. 8 shows another exemplary user interface 100 presented by one of applications 61 of computing device 50 of FIG. 4. If user 51 is one of reviewers 7, user 51 may log into system 3 and view user interface 100. User interface 100 presents a grid or spreadsheet-like table 101 containing a composite forecast. This composite forecast is based on the aggregation of business-as-usual contribution data and task-specific contribution data.

User 51 may learn more about the data in a cell of table 101 by right-clicking on the cell. When user 51 right-clicks on a cell of table 101, user interface 100 may display sub-menu 102. Sub-menu 102 includes a “Task Trail” option. When user 51 selects the “Task Trail” option of sub-menu 102, user interface 100 displays a task trail window 104. Task trail window 104 presents a task trail that specifies information about tasks that have an impact on the cell of table 101.

User 51 may use task trail window 104 to perform a variety of actions with regard to the tasks in the task trail. For example, when user 51 clicks the right mouse button when the cursor resides over an entry in task trail window 104, task trail window 104 may display sub-menu 106. For example, user 51 may right-click the “FTE plan adjusted” task in the task trail.

Sub-menu 106 includes a “show details” option, a “show impact” option, and a “roll back” option. If user 51 selects the “Show Impact” option of sub-menu 106, user interface 100 may display the impact of accepting the “FTE plan adjusted” task trail entry in table 101. In this way, user interface 100 presents a composite forecast based on the included one or more sequential plurality of pending changes to the task data. If user 51 selects the “Roll Back” option of sub-menu 106, user interface 100 may update table 101 to reflect rolling back (i.e., rejecting) the impacts specified by the “FTE plan adjusted” task log entry. If user 51 selects the “Show Details” option of sub-menu 106, user interface 100 may open another user interface that presents a detailed view of the changes pertaining to the selected task log entry. In this manner, user 51 may easily manage and review changes to task data when compared to conventional grid or spreadsheet like views. Moreover, reviewers 7 may easily view details concerning those changes and identify the impacts of accepting such changes within the grid or spreadsheet like view of user interface 100.

Throughout these interactions, user interface 100 may query data store 58 to populate both table 101 and task trail window 104. In other embodiments, user interface 100 may query contribution module 32 in system 3 to populate these windows.

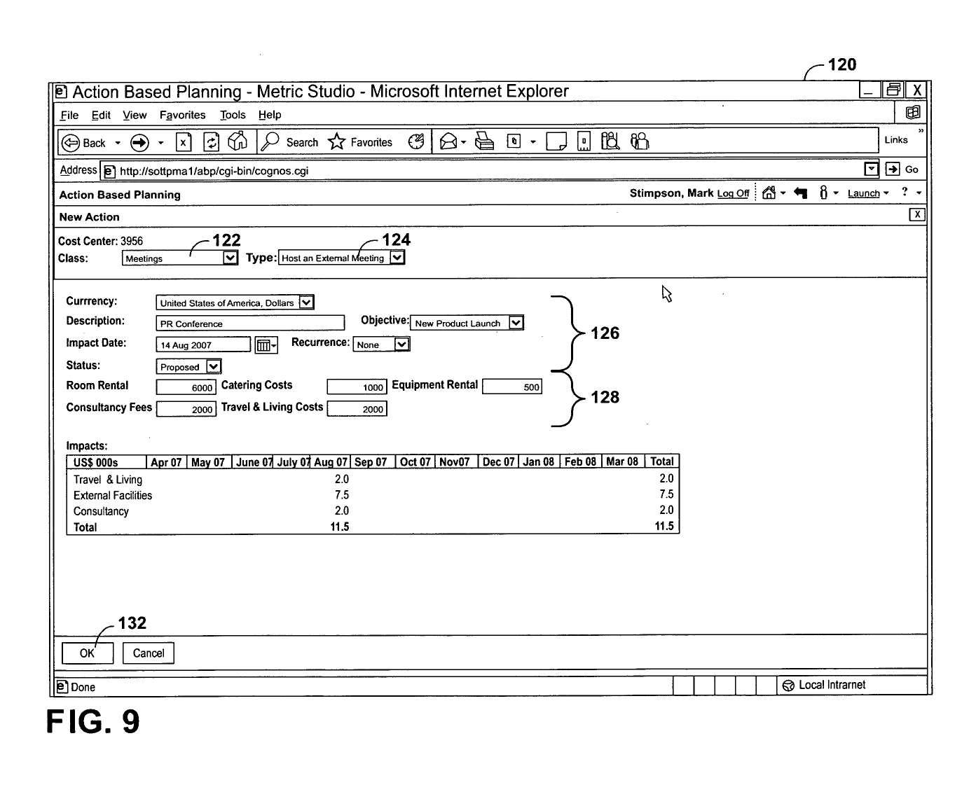

FIG. 9 is a screenshot illustrating an exemplary task-specific form 120 presented by client device 50 (FIG. 4) by which one of users 19 may enter task data regarding a new action. Some actions and tasks are likely to be performed more than once. For example, enterprise 4 may occasionally hold meetings at conference centers. Each time enterprise 4 performs such an action or task, one of contributors 6 provides similar types of task-specific contribution data regarding the action or task. However, each time enterprise 4 performs such an action or task, the particular impacts of performing the action or task might be different. In the previous example, the conference center might charge two different rates for two different meetings. For this reason, analysts 8 may design task-specific forms that are tailored to capture task-specific contribution data regarding different types of actions or tasks that are likely to arise again in the future.

Task-specific form 120 represents a task-specific form that has been tailored to capture task-specific contribution data regarding the task of hosting an external meeting. As illustrated in the example of FIG. 9, task-specific form 120 includes a dropdown box 122 that allows user 51 to select an action class. An action class is a general category of actions. In addition, task-specific form 120 includes a dropdown box 124 that allows user 19 to select an action type. An action type is a specific type of action within the selected action class. As illustrated in the example of FIG. 9, user 19 has used dropdown box 122 to select “Meetings” as the action class of the new action and has used dropdown box 124 to select “Host an External Meeting” as the action type of the new action.

When user 19 uses dropdown box 122 and dropdown box 124 to select an action class and an action type, task-specific form 120 displays a set of standard input fields 126. The set of standard input fields 126 includes input fields associated with action data that system 3 requires for all actions. As illustrated in the example of FIG. 9, set of input fields 126 includes a “currency” input field, a “description” input field, an “objective” input field, an “impact date”, a “recurrence” input field, and a “status” input field. It should be appreciated that in other implementations of system 3 set of standard input fields 126 may include different input fields.

In addition to standard input fields 126, task-specific form 120 displays a set of action-specific input fields 128. Action-specific input fields 128 are associated with the action class that user 19 selected using dropdown box 122 and the action type that user 19 selected using dropdown box 124. As illustrated in the example of FIG. 9, set of action-specific input fields 128 includes a “room rental” input field, a “catering costs” input field, an “equipment rental” input field, a “consultancy fees” input field, and a “travel and living costs” input field.

As discussed above, analysts 8 may design new classes of actions and new types of actions. When one of analysts 8 designs a new type of action, the analyst may identify types of task-specific contribution data may be associated with instances of the new type of action. For instance, the analyst may identify “Room Rental” costs, “Catering Costs”, “Equipment Rental” costs, “Consultancy Fees”, and “Travel & Living” costs as types of task-specific contribution data associated with instances of the new type of action. The analyst may then include an input field in the set of action-specific input fields 128 for each of the identified types of task-specific contribution data that are associated with the new type of action.

Next, the analyst may identify one or more new or existing variables in a multidimensional dataset that are affected (i.e., impacted) by instances of the new type of action. For instance, the analyst may identify a “Travel & Living” variable, an “External Facilities” variable, and a “Consultancy” variable as variables affected by instances of the new type of action. Furthermore, when one of analysts 8 designs a new type of action, the analyst may map individual ones of action-specific input fields 128 to the identified variables in the multidimensional dataset. By mapping one of action-specific input fields 128 to a variable, the analyst may effectively indicate that values entered into the action-specific input field have an impact on the variable.

After identifying the variables that are affected by instances of the new type of action, the analyst may determine when the variables will be affected by instances of the new type of action. In a first example, the analyst may determine that instances of the new type of action will affect all of the variables during the month in which the instances of the new type of action are performed. In a second example, the analyst may determine that instances of the new type of action will affect one of the variables for each month that follows the month in which the instances of the new type of action are performed. This may be the case with regard to a salary variable for instances of a task that involves hiring an employee. Furthermore, in this second example, the analyst may determine that instances of the new type of action will affect a second one of the variables only during the month in which the instances of the new type of action are performed. After determining when the instances of the new type of action will affect the variables, the analyst may configure the mapping such that values based on the values entered into action-specific input fields have the appropriate impacts on the variables. At this stage, the analyst may make task-specific form 120 ready to be used by contributors 6.

Task-specific form 120 includes an impacts pane 130. Impacts pane 130 presents a forecast that indicates how the action will impact the variables. For instance, impacts pane 130 lists each variable that is “impacted” by values entered in one or more of action-specific input fields 128. When user 51 enters values in action-specific input fields 128, client software application 52 may automatically generate task-specific contribution data based on the values entered in required input field 126 and action-specific input fields 128. Client software application 52 may then automatically update impacts pane 130 such that the variables mapped to the action-specific input fields reflect the entered values. For example, one of analysts 8 may have mapped the “consultancy fees” input field in the set of action-specific input fields 128 to a “consultancy” variable. Furthermore, as illustrated in the example of FIG. 9, user 51 has entered the monetary value of $2,000 in the “consultancy fees” input field. Because the analyst mapped the “consultancy fees” input field to the “consultancy” variable, client software application 52 automatically generates task-specific contribution data associated with the “consultancy” variable and updates impacts pane 130 such that the “consultancy” variable reflects the monetary value of $2,000.

Analysts 8 may also map a plurality of action-specific input fields 128 to a single variable. In the example of FIG. 9, one of analysts 8 may have mapped the “room rental” input field, the “catering costs” input field, and the “equipment rental” input field to an “external facilities” financial variable. Furthermore, as illustrated in the example of FIG. 9, user 51 has entered the value of $6000 in the “room rental” input field, the value of $1000 in the “catering costs” input field, and the value of $500 in the “equipment rental” input field. Because the analyst mapped the “room rental” input field, the “catering costs” input field, and the “equipment rental” input field to the “external facilities” financial variable, client software application 52 automatically generates the task-specific contribution data of $7,500 and updates impacts pane 130 such that the “external facilities” financial variable reflects the aggregated monetary value of $7,500.

Impact pane 130 also reflects when values entered in action-specific input fields 128 have impacts on the variables. As illustrated in the example of FIG. 9, user 51 has entered the date “14 Aug. 2007” into the “impact date” input field. By entering this date into the “impact date” input field, user 51 effectively schedules each of the monetary values entered in action-specific input fields 128 to impact the financial variables during August of 2007.

After user 51 enters data into required input fields 126 and action-specific input fields 128, user 51 may select an “OK” button 132. When user 51 selects “OK” button 132, client software application 52 may create a new set of action data in data store 58. This new set of action data may specify the values entered into required input fields 126 and the values entered into action-specific input fields 128 as properties of the new instance of the action. In addition, client software application 52 may store the task-specific contribution data into a multidimensional dataset in data store 58.

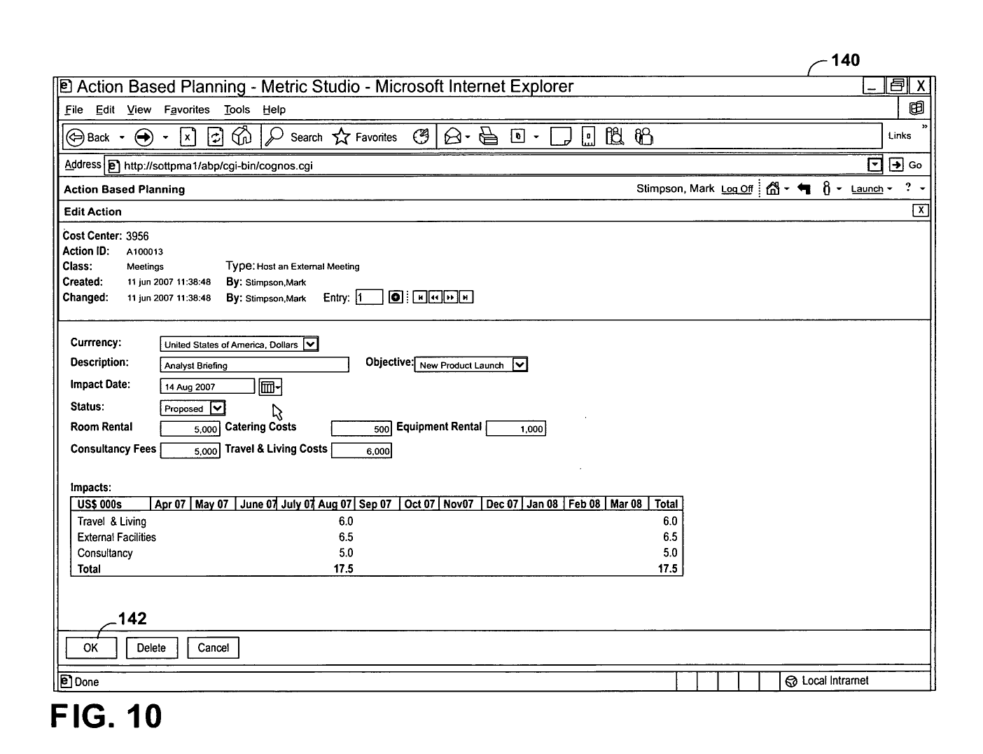

FIG. 10 is a screenshot illustrating an exemplary action editing interface 140 presented by computing device 50 of FIG. 4. User 51 may use action editing interface 140 to edit values associated with an existing action. In the example of FIG. 10, user 51 may use action editing interface 140 to edit values associated with the action created using task-specific form 120 in the example of FIG. 9. Thus, one of users 19 may edit the values of properties of the action by editing the values in the “currency” input field, the “description” input field, the “objective” input field, the “impact date” input field, the “status” input field, the “room rental” input field, the “catering costs” input field, the “equipment rental” input field, the “consultancy fees” input field, and the “travel and living costs” input field. However, action editing interface 140 does not allow user 51 to change the class or the type of the action because changing the class or type of the action may change which input fields would be available. Furthermore, action editing interface 140 does not allow user 51 to change the values that indicate when the action was created or the value that indicates who created the action.

Action editing interface 140 includes an “OK” button 142. When user 51 selects “OK” button 142, client software application 52 may generate task-specific contribution data from the values in the input fields of action editing interface 140. Client software application 52 may then store the task-specific contribution data in a multidimensional dataset in data store 58. In addition, client software application 52 may update the properties of the action.

Subsequently, user 51 may instruct client software application 52 to save data store 58 back to system 3. In response, client software application 52 may send data store 58 to system 3. Upon receiving data store 58, system 3 may update values associated with the action within the context of a “scenario.” All “scenarios” may include all actions users 19 have been created. However, the same action in two different scenarios may be associated with different values. For example, in a first scenario the “consultancy fees” property of an action having action ID “A100013” may have the value $5000 and in a second scenario the “consultancy fees” property of the action having action ID “A100013” may have the value $4000. By creating multiple scenarios and entering different values for the properties of the same actions, users 19 may be able to compare the scenarios in order to determine which one of the scenarios represents a better course of action for enterprise 4.

Scenarios may be visible to ones of users 19 other than the one of users 19 who created the scenario or who edited values of properties of an action in the scenario. For example, some scenarios may be “individual” scenarios. “Individual” scenarios are scenarios that are visible to a one of users 19 who created the scenario and any user who is above this user in enterprise hierarchy. In another example, some scenarios may be “shared” scenarios. “Shared” scenario are scenarios that are visible to a one of users 19 who created the scenario, any user who is above this user in the enterprise hierarchy, and any user who is below or at the same level of the enterprise hierarchy as this user and who has been nominated by this user. In another example, a “standard” scenario may be visible to each one of users 19. The “standard” scenario may represent the actual business plan of enterprise 4.

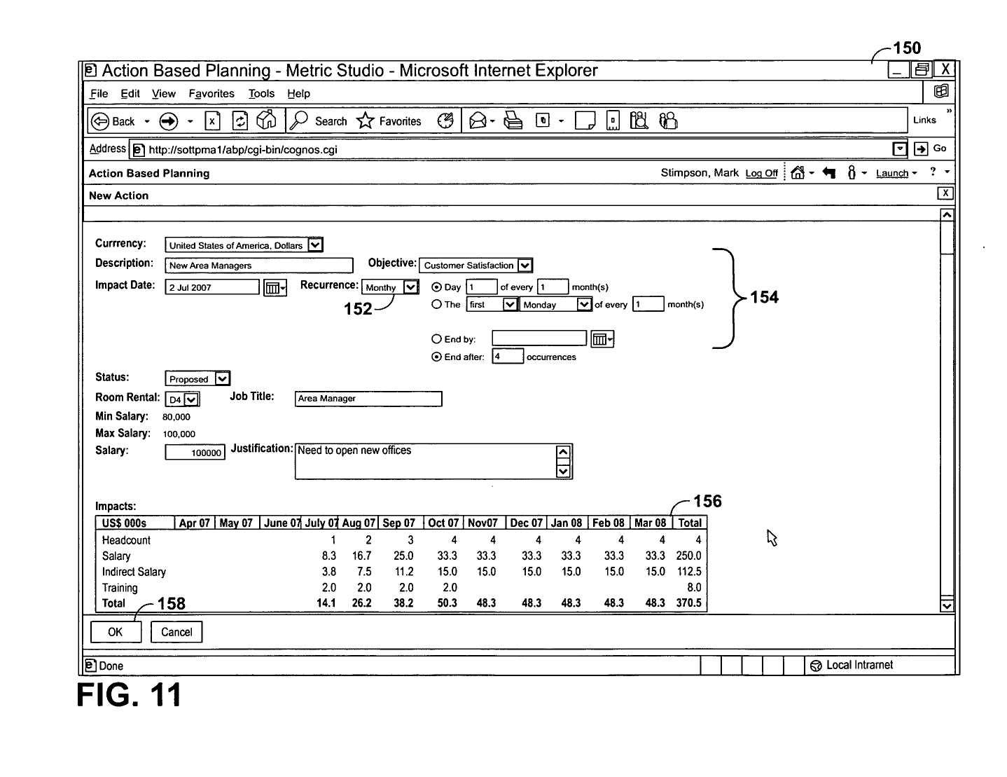

FIG. 11 is a screenshot illustrating an exemplary task-specific form 150 in which user 51 is configuring an action to recur. Like task-specific form 120, task-specific form 150 includes a recurrence dropdown box 152. In the example of FIG. 11, user 51 has selected the value “monthly” in recurrence dropdown box 152.

When user 51 selects the “monthly” recurrence period in recurrence dropdown box 152, client software application 52 may automatically display a set of recurrence input fields 154. Recurrence input fields 154 allow the user to input recurrence information. For example, when user 51 selects the “monthly” recurrence period in recurrence dropdown box 152, recurrence input fields 154 include input fields that allow the user to specify when actions in the recurring series of actions are scheduled to have financial impacts. In the example of FIG. 11, user 51 has used recurrence input fields 154 to specify that actions in this recurring series of actions are scheduled to have financial impacts on the first day of each month. In addition, when user 51 selects the “monthly” recurrence period in recurrence dropdown box 152, recurrence input fields 154 include input fields that allow user 51 to specify how many times the action will recur. In the example of FIG. 11, recurrence input fields 154 include input fields that allow user 51 to specify how many times the action will recur by including input fields that allow the user to specify a date by which the last action in series of actions will occur and may also include input fields that allow the user to explicitly specify how many times the action is to recur.

Although not illustrated in the example of FIG. 11, other values in recurrence dropdown box 152 may include daily recurrence, quarterly recurrence, semiannual recurrence, yearly recurrence, and/or other recurrence periods. Client software application 52 may automatically display different sets of recurrence input fields for each of these different recurrence periods. For example, if user 51 selects the daily recurrence period in recurrence dropdown box 152, it would not make sense to give the user the option of specifying the day of the month on which the recurring actions have financial impacts.

When user 51 inputs recurrence information into recurrence input fields 154, client software application 52 may automatically update an impacts pane 156 to reflect the impacts of the series of recurring actions on variables of the multidimensional dataset affected by the series of recurring actions. In the example of FIG. 11, user 51 has specified that the series of recurring actions includes four actions that recur on a monthly basis, starting on the second day of July, 2007. Accordingly, impacts pane 156 shows the effects of the aggregated task-specific contribution data of this series of four recurring actions on the variables affected by the series of recurring actions. For instance, the “July 07” column of impacts pane 156 specifies that the aggregated task-specific contribution data of the series of recurring actions causes an impact of “1” on the “headcount” variable, an impact be equal to $8,333 (i.e. $100,000/twelve months) on the “salary” variable, an impact equal to $3,800 on the “indirect salary” variable, and an impact equal to $2000 on the “training” variable. Note that in the example of FIG. 11, monetary values are rounded to the nearest tenth of one thousand dollars. Furthermore, in “August 07”, two instances of the action have been performed. Accordingly, the “August 07” column of impacts pane 156 specifies that the aggregated task-specific contribution data of the series of recurring action causes an impact equal to two on the “headcount” variable, an impact equal to $16,700 (i.e., $8,333+$8,333) on the “salary” variable an impact equal to $7,500 (i.e., $3,800+$3,800) on the “indirect salary” variable, and an impact equal to $2000 on the “training” variable. The value of the “training” variable in August '07 is equal to $2,000 because training expenses for each hired manager only have impacts during the month in which enterprise 4 hired the manager, as opposed to the salary variables which continue to have impacts during each month the manager works at enterprise 4.

Task-specific form 150 also includes an “OK” button 158. When user 51 selects “OK” button 158, client software application 52 may create a new separate set of action data for each action in the series of recurring actions. For example, if the series of recurring actions includes four actions, client software application 52 may create four new separate sets of action data when user 51 selects “OK” button 158.

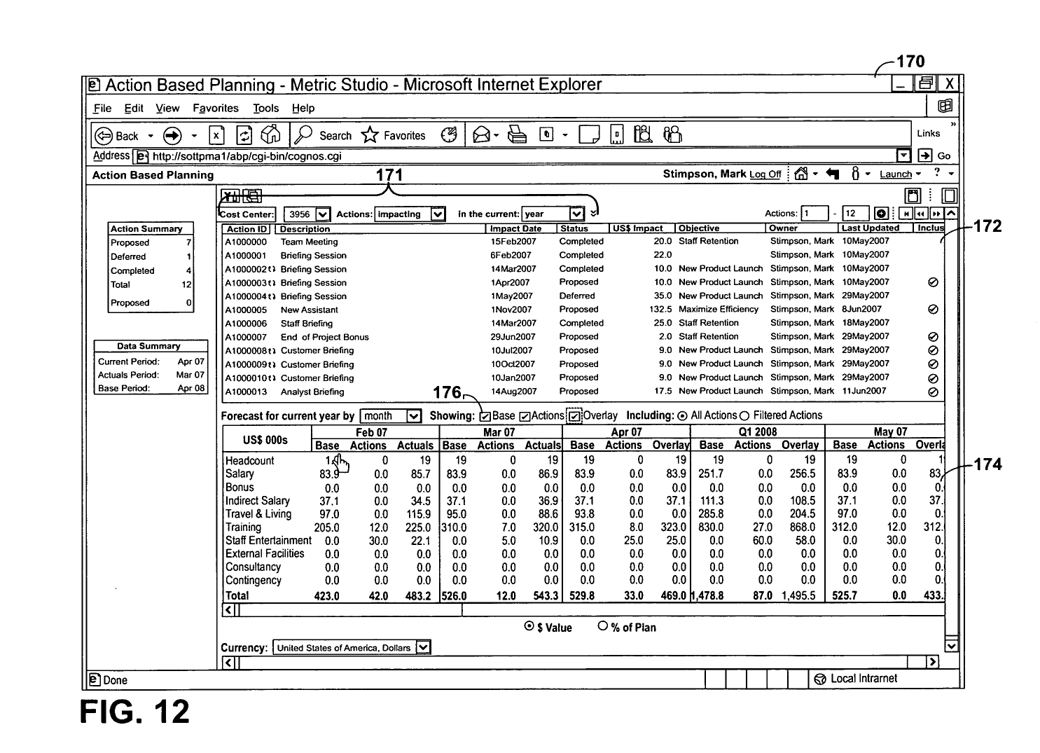

FIG. 12 is a screenshot illustrating an exemplary action review interface 170 presented by client software application 52. Action review interface 170 includes an action pane 172 that presents a task log that lists actions and/or tasks that have been configured in system 3 that satisfy filter criteria 171. In the example of FIG. 12, an action satisfies filter criteria 171 when the action is related to cost center 3956 and has an impact during the current year. Furthermore, in the example of FIG. 12, action pane 172 displays an “action ID”, a “description,” an “impact date,” a “status,” a “US$ Impact,” an “objective,” an “owner,” a “last updated,” and an “included” value associated with for each action. For example, action pane 172 displays an “action ID” of A100006, a description of “Staff Briefing”, an impact date of “14 Mar. 2007”, a status of “Completed”, a US$ impact of “25.0”, an objective of “Staff Retention”, an owner of “Mark Stimpson”, a last updated value of “18 May 2007”, and no checkmark for the “included” column. An “action ID” of an action specifies identifier for the action. A “description” of an action specifies a description of the action. A “cost center” of an action specifies a numerical code associated with a cost center that is undertaking the action. As described above, a “cost center” is a unit of an enterprise (e.g., an office, division, department, etc.) that expends enterprise money. An “impact date” of an action specifies a date when effects of the action will occur. A “status” of an action specifies a status of the action. For example, an action may have a status of “proposed,” “completed”, or “deferred.” In this example, an action having a status of “proposed” is an action that has been entered into system 3, and has not been performed and is still scheduled to occur at time when the action was originally scheduled to be performed. An action having a status of “completed” is an action that is complete. An action having a status of “deferred” is an action that has been entered into system 3, but is not longer scheduled to occur at a time when the action was originally scheduled to be performed. A “US$ Impact” of an action is an estimate of how much enterprise money will have to be expended in order to complete the action. An “objective” of an action is a description of the purpose of the action. An “owner” of an action specifies a person who is responsible for decisions regarding the action. A “last updated” value of an action specifies a date on which information regarding the action was last updated. An “included” value of an action specifies whether the action is included in a forecast.

Action review interface 170 also includes a forecast pane 174. Forecast pane 174 presents impacts of the included actions on various variables over the course of one or more time periods. As shown in the example of FIG. 12, forecast pane 174 presents eleven different variables: “Headcount”, “Salary”, “Bonus”, “Indirect Salary”, “Travel & Living”, “Training”, “Staff Entertainment”, “External Facilities”, “Consultancy”, “Contingency”, and “Total”. Although not shown to user 51, these eleven variables may be items along a “Variables” dimension of an underlying multidimensional dataset in data store 54. Furthermore, as shown in the example of FIG. 12, forecast pane 174 presents the time periods “Feb. 7”, “Mar. 7”, “Apr. 7”, “Q1 2007”, and “May 7”. Although not shown to user 51, these time periods may be items along a “Time” dimension of the underlying multidimensional dataset. In forecast pane 174, time periods may be characterized as “current”, “previous”, “historical”, or “future.” A “current” time period is a time period that includes the present time. A “previous” time period is a time period that immediately preceded to current time period. A “historical” time period is any time period that preceded the “previous” time period. A “future” time period is any time period that follows the “current” time period.

Users 19 may use check boxes 176 to cause system 3 to display different types of impacts in forecast pane 174. For example, enterprise users 19 may use check boxes 176 to cause system 3 to display a “Base” forecast, an “Action” forecast, and/or an “Overlay” forecast. Although not shown to user 51, these types of forecast may be items along a “Forecast” dimension of the underlying multidimensional dataset. The “base” forecast in forecast pane 174 may be based on business-as-usual contribution data associated with ordinary operation of enterprise 4. As presented in forecast pane 174, each number in the base forecast indicates the combined impact of business-as-usual activities on a variable during a time period. For instance, the base forecast indicates that the combined impact of the business-as-usual activities on the “training” variable during “February 07” is $205,000.

An action forecast in forecast pane 174 may be based on task-specific contribution data associated with ones of the actions presented in action pane 172 that are marked as “included.” As presented in forecast pane 174, each number in the action forecast indicates the combined impact of the included actions on a variable during a time period. For example, the action forecast indicates that the combined impact of included actions on the “training” variable during “February 07” is $12,000.

Furthermore, in the example of FIG. 12, the action forecast in forecast pane 174 for a variable during a “historical” or “previous” time period may indicate the combined impact of included actions listed in action pane 172 that have impact dates during the period, that are associated with the variable, and that have a status of “completed.” An action impact for a variable during the “current” time period may indicate the combined impact of included actions listed in action pane 172 that have impact dates during the current period, that are associated with the variable, and that have a status of “completed” or “proposed.” An action impact for a variable during a “future” time period may indicate the combined impact of included actions listed in action pane 172 that have impact dates during the “future” period, that are associated with the variable, and that have a status of “proposed” or “completed.” In addition, an action impact for a variable and a “future” time period may include the impacts of actions that have a status of “proposed” or “completed”, that have impacts in “previous” or “current” time periods, and that have continuing impacts in the “future” time period.

In general, a composite forecast (labeled “Overlay” in the example of FIG. 12) is based on aggregate contribution data that results from aggregating business-as-usual contribution data and corresponding task-specific contribution data associated with ones of the actions presented in action pane 172 that are marked as “included.” As presented in forecast pane 174, each number in the composite forecast indicates the aggregate contribution data of the variable during a time period. For example, the composite forecast indicates that the aggregate contribution data of the “training” variable during “Apr. 7” is $323,000. As described in detail below, a set of customizable overlay calculations may be associated with each variable. When calculation engine 54 forms the aggregation contribution data, calculation engine 54 may perform the overlay calculations associated with each of the variables in order to generate the aggregate contribution data for the variables. For example, analysts 8 may create a customized overlay calculation for a variable that specifies that aggregate contribution data for the variable for a first month is equal to the sum of the task-specific contribution data and the business-as-usual contribution data for the variable and for the first month. Furthermore, in this example, analysts 8 may create a customizable overlay calculation for the variable that specifies that an aggregate contribution data for the variable for a second month are equal to only the task-specific contribution data for the variable during the second month.

In addition to base forecast, action forecast, and overlay forecast, forecast pane 174 includes “actual” impacts for time periods that preceded the current period. In the example of FIG. 12, the current period is April 2007 and time periods that precede April 2007 (i.e., February 2007 and March 2007) forecast pane 174 include actual impacts. An actual impact for a variable and time period indicates the real impact of the business-as-usual contribution data for the variable during the time period and the task-specific impact for the variable during the time period. In other words, the actual impact for a variable and a time period indicates what actually happened to the variable during the time period. Because the actual impact for a variable and a time period indicates what actually happened to the variable during the time period, forecast pane 174 does include display actual impacts for the current time period or any future time period.

As mentioned above, the impacts of an action on a variable may continue after the time period in which the initial impacts of the action on the variable occur. For example, enterprise 4 may undertake an action to hire an employee. In this example, enterprise 4 must continue to pay the employee's salary each month. Hence, the impacts of the action of hiring the employee on the “salary” variable continue after the time period in which the initial impacts of the action occur (i.e., the time period in which enterprise 4 hired the employee). However, the impacts of the same action on a different variable may only occur during the month in which the action was completed. For example, the action to hire an employee may, in addition to the impacts on the “salary” variable, have an impact on the “training” variable. In this example, the impact of the action on the “training” variable may only occur during the time period in which the action was completed because after this time period, the new employee no longer needs any training.

Because the impacts of an action on a variable may continue after the time period in which the initial impacts of the action on the variable occur, the impacts of the action on the variable in time periods after the initial time period may be incorporated into the business-as-usual contribution data of the variable in subsequent time periods. For example, before undertaking any action that has an impact on the “salary” variable, enterprise 4 may expect to pay $83,900 in salaries in March 2007. For this reason, the business-as-usual contribution data of the salary variable for March 2007 is $83,900. In this example, enterprise 4 may undertake an action in March 2007 to hire a new employee who has a monthly salary of $5,000. Forecast pane 174 would reflect this action as a $5,000 impact on the salary variable for March 2007. If enterprise 4 successfully hires the new employee having a monthly salary of $5,000, the base impact on the salary variable for April 2007 and subsequent months is now $88,900 (i.e., $83,900+$5,000).

However, it is not always the case that the business-as-usual contribution data of a variable in a time period is equal to the actual impact on the variable in the time period. For example, an employee may unexpectedly quit working for enterprise 4 in the middle of the current period. In this example, the base impact on the variable in the current time period is greater than the actual impact on the variable in the current time period. Furthermore, the actual impact on a variable in a given time period might not be known for several time periods after the given time period. For example, enterprise 4 might not know how much it has to pay for telephone service for a given month until the telephone company sends the bill for telephone service in a following month.

Because the actual business-as-usual contribution data may not be known for several time periods, it may not be possible to incorporate the continuing impacts of actions into the actual business-as-usual contribution data. Rather, system 3 may incorporate the continuing impacts of actions to the most recent actual business-as-usual contribution data. Subsequently, when the actual business-as-usual contribution data for a time period is known, system 3 may automatically update (i.e., roll-over) the business-as-usual data for time periods that follow this time period to reflect the actual business-as-usual contribution data plus the continuing impacts of actions that have been incorporated into the business-as-usual contribution data.

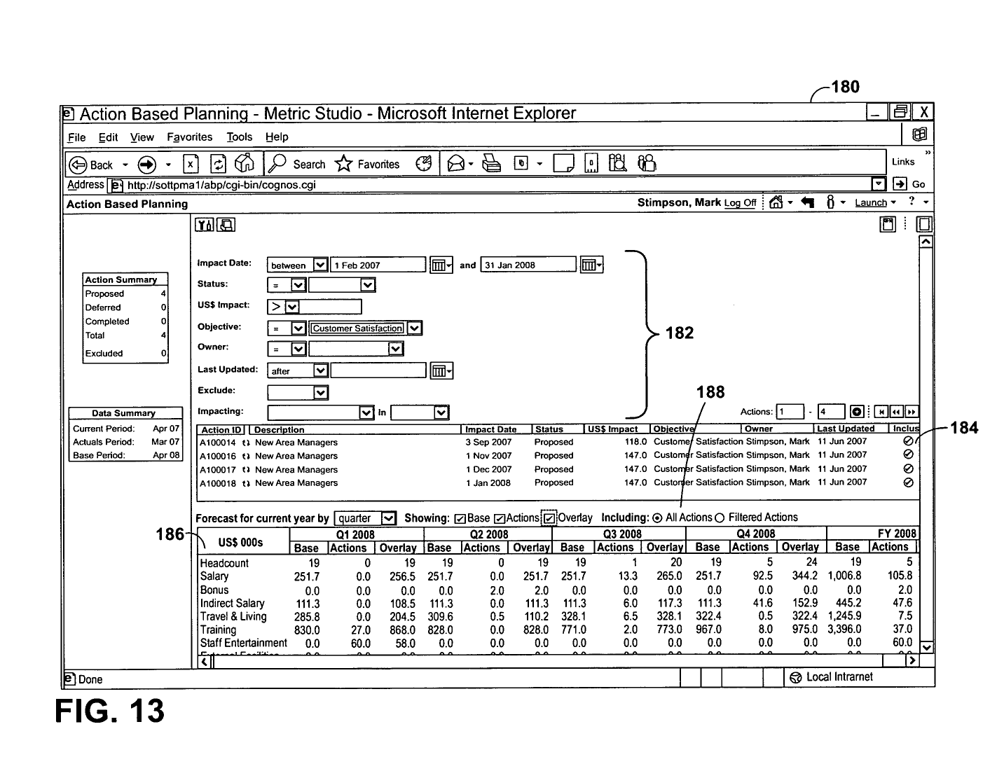

FIG. 13 is a screenshot illustrating an exemplary action review interface 180 presented by computing device 50 (FIG. 4) that includes a set of input boxes 182 to filter actions in an action pane 184. Action review interface 180 is similar to action review interface 170 except that action review interface 180 includes input boxes 182. One of user 51 may use input boxes 182 to specify criteria regarding relevant actions. These criteria may be properties of relevant actions or other information about relevant actions. As illustrated in the example of FIG. 13, user 51 may use input boxes 182 to specify an “impact date” property of relevant actions, a “status” property of relevant actions, a “US$ Impact” property of relevant actions, an “objective” property of relevant actions, an “owner” property of relevant actions, a “last updated” property of relevant actions. Furthermore, input boxes 182 include an “exclude” dropdown box that allows the user to control whether actions that meet the criteria specified in other ones of input boxes 182 are included in the list of actions in action pane 184 or excluded from the list of actions in action pane 184. In addition, input boxes 182 include dropdown boxes that allow the user to identify actions based on which variables the actions impacts.

When the user uses input boxes 182 to specify criteria regarding relevant actions, action pane 184 only displays those actions that satisfy the specified properties or other information. In the example of FIG. 13, user 51 has used input boxes 182 to specify that relevant actions have an impact data between 1 February 2007 and 31 Jan. 2008 and that relevant actions have an objective of “customer satisfaction.” Furthermore, as illustrated in the example of FIG. 13, action pane 184 displays four actions: an action having action ID A100014, an action having action ID A100016, an action having action ID A100017, and an action having action ID A 100018.

Action review interface 180 also includes a forecast pane 186. Forecast pane 186 is similar to forecast pane 174 in the example of FIG. 12. User 51 may use radio buttons 188 to select whether forecast pane 186 includes forecasts of all actions or just forecasts of actions that satisfy the criteria specified in input boxes 182. User 51 may determine that forecast pane 186 should include forecasts for actions that satisfy the criteria specified in input boxes 182 when user 51 is attempting to understand the impacts of a specific set of actions.

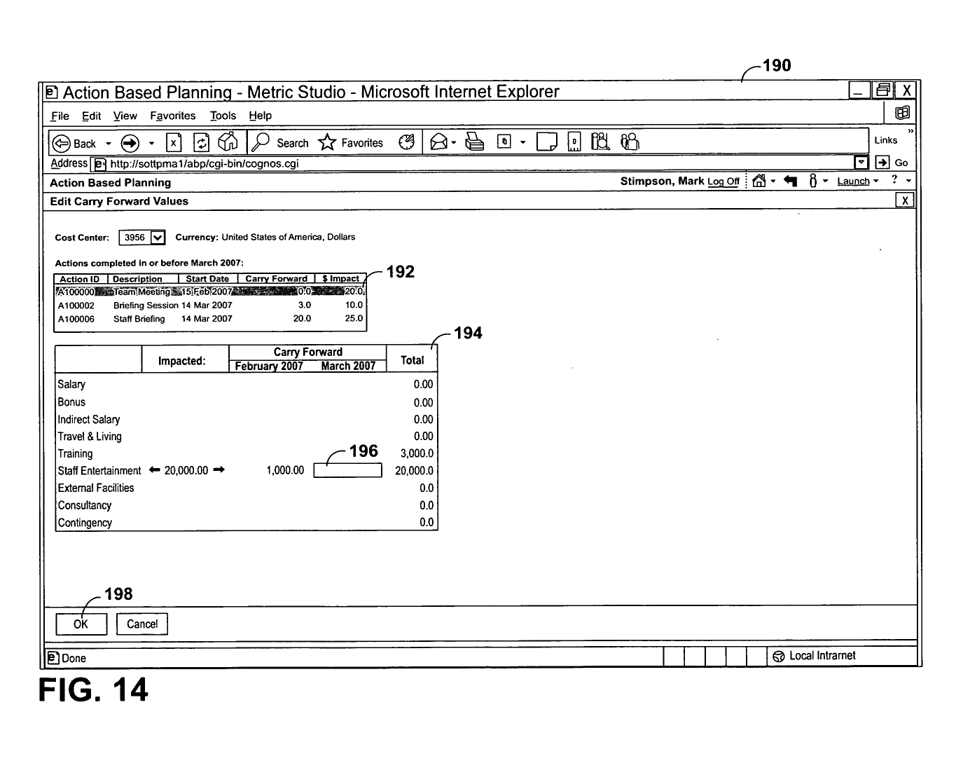

FIG. 14 is a screenshot illustrating an exemplary carry-forward interface 190 presented by computing device 50 of FIG. 4. Carry-forward interface 190 includes an action pane 192. Action pane 192 lists actions that were completed prior to the current period. In the example of FIG. 14, the current period is “March 2007” and there are three actions: a “Team Meeting” action, a “Briefing Session” action, and a “Staff Briefing” action.

In general, revenues and expenses associated with an action or task accrue to enterprise 4 during the month in which the action or task is completed. For example, if enterprise 4 holds a meeting in January 2007, expenses associated with the meeting (e.g., catering, hall rental, etc.) accrue to enterprise 4 during January 2007. Nevertheless, enterprise 4 does not necessarily pay for all expenses accrued during a month during that month. In other words, expenses accrued during one month may be carried over into the next month. For example, if enterprise 4 holds a meeting in January 2007 at which a caterer delivered food, the caterer might not send an invoice to enterprise 4 for the food until February 2007. In this example, impacts to enterprise 4 (i.e., payment of the invoice for the food) associated with the action (i.e., holding the meeting) do not occur during the time period in which the action was completed. When an impact to enterprise 4 associated with an action does not occur during the period in which the action was completed, this impact may be “carried-over” into a time period that follows the time period in which the action was completed. Furthermore, if this impact does not occur in the time period that follows that time period in which the action was completed, this impact may be “carried-over” into a next successive time period, and so on.

When a impact is “carried-over” from a first time period into a second time period, the financial impact is not incorporated into the actual impacts for the first time period. Rather, the “carried-over” impact is incorporated into the action impacts for the second time period. Because the impacts associated with an action may be associated with more than one variable, and because some of the impacts associated with the action may be realized in the first time period, some of the impacts associated with the action may be incorporated into the actual impacts for the first time period and some of the financial impacts associated with the action may be incorporated into the action impacts for the second time period.

User 51 may use carry-forward interface 190 to specify financial impacts associated with an action to be carried forward into a time period that follows a current time period. In order to use carry-forward interface 190 to specify financial impacts associated with an action to be carried forward into a time period that follows a current time period, user 51 may select the action from action pane 192. When user 51 selects the action, client software application 52 causes an impacts pane 194 in carry-forward interface 190 to automatically display impacts associated with the action on different variables. As illustrated in the example of FIG. 13, user 51 has selected the “team meeting” action which has a total financial impact of $20,000. Furthermore, because user 51 has selected the “team meeting” action, impacts pane 194 displays the value of $20,000 next to the “staff entertainment” variable, thereby indicating that all of the impacts of the “team meeting” action are associated with the “staff entertainment” variable. Impacts pane 194 also displays the value of $1,000 in a column associated with February 2007, indicating that $1,000 of the $20,000 associated with the “staff entertainment” variable have already been realized. In addition, impacts pane 194 includes an input box 196 associated with March 2007 and the “staff entertainment” variable. User 51 may use input box 196 to enter an amount of money that should be carried forward from February 2007 into March 2007.

Carry-forward interface 190 includes an “OK” button 198. When user 51 selects “OK” button 198, system 3 may update planning data 42C (FIG. 4) to indicate that an amount of money entered into input box 196 is carried forward into the time period associated with input box 196.

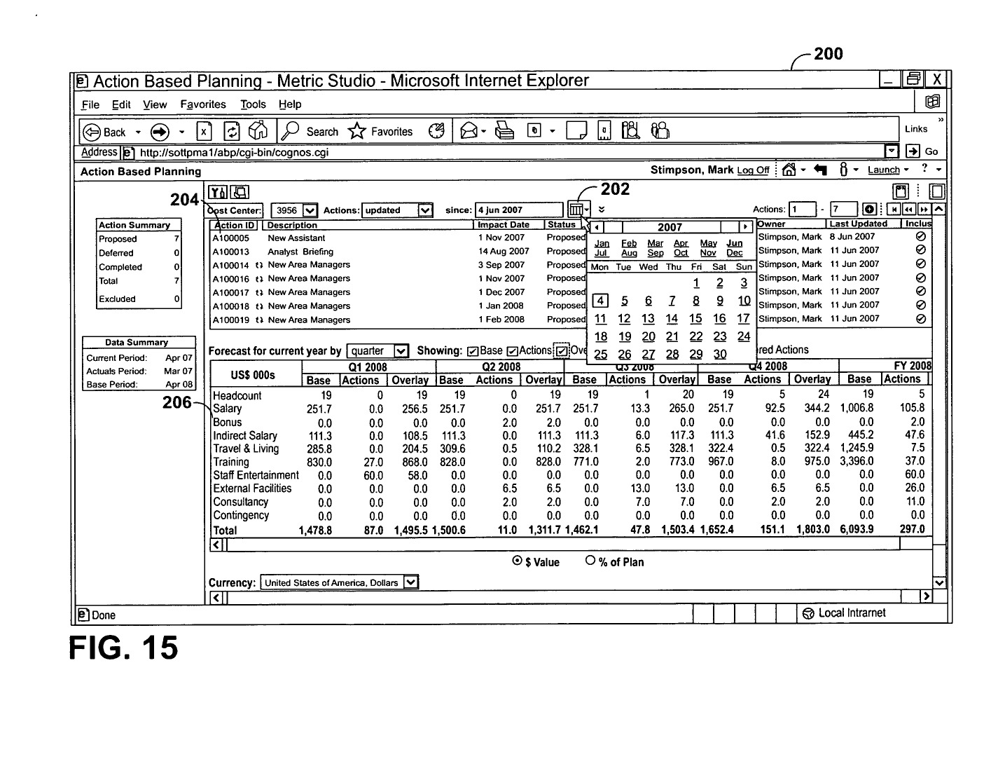

FIG. 15 is a screenshot illustrating a forecast interface 200 presented by computing device 50 in which user 51 views a forecast as it would appear if actions that occurred after a selected date had not occurred. User 51 may use an “updated since” dropdown box 202 to select a date. When user 51 selects a date using dropdown box 202, client software application 52 automatically updates an action pane 204 such that action pane 204 only includes actions that were updated since the selected date. Furthermore, forecast interface 200 includes a forecast pane 206. Although not shown in the example of FIG. 15, forecast interface 200 includes radio buttons, similar to radio buttons 188 in FIG. 13, that allow user 51 to select whether forecast pane 206 includes all actions or only actions listed in action pane 204. Use of these radio buttons may allow the user to understand the impacts of actions that have been updated after a specified time.

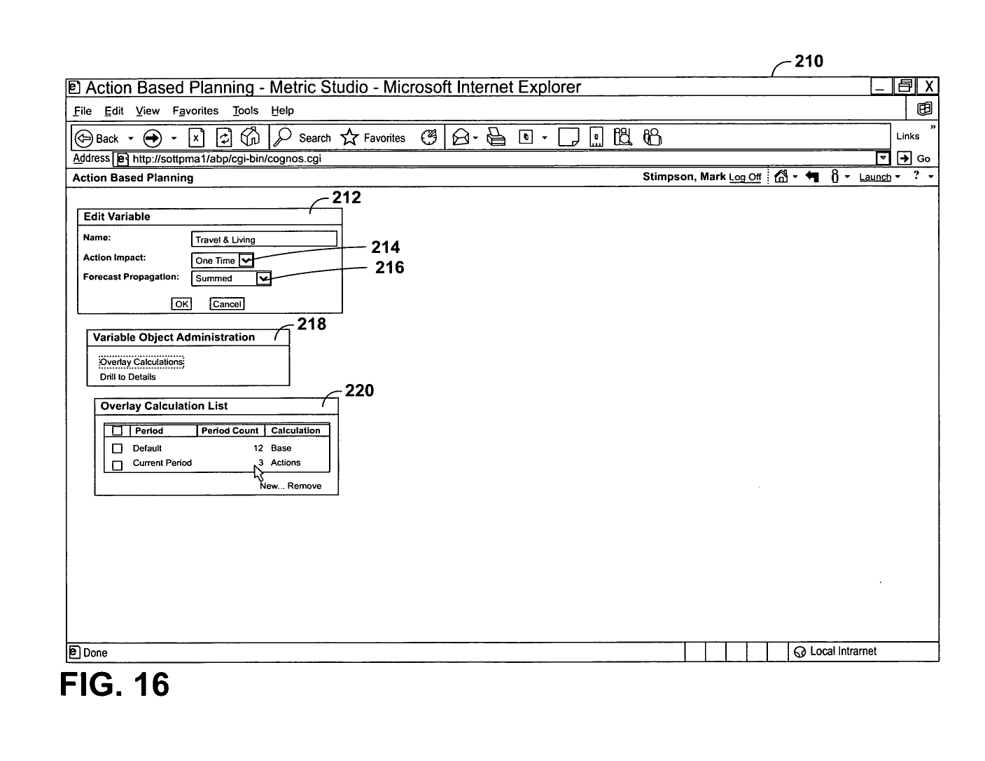

FIG. 16 is a screenshot illustrating an example variable editing interface 210 presented by computing device 50. Variable editing interface 210 includes an edit variable pane 212 that allows user 51 to edit general information about a variable. In the example of FIG. 16, edit variable pane 212 includes input boxes that allow user 51 to update the name of a variable, the action impact of the variable, and the forecast propagation of the variable. The name of the variable may be the name of the variable that appears in forecast pane 204 and in other locations. In the context of a multidimensional dataset, the name of the variable may be the name of an item along the “variable” dimension of the multidimensional dataset.

Edit variable pane 212 includes an “action impact” dropdown box 214 that allows user 51 to specify whether the impacts of actions on the variable are one-time occurrences or whether the impacts of actions on the variable continue to have impacts on the variable after the month in which the impacts are scheduled to occur. In a first example, an action that entails travel expenses may have an impact on a “travel and living” variable. In this first example, the impact of this action occurs only when enterprise 4 pays the bills for the travel expenses. However, in a second example, an action in which enterprise 4 hires an employee may have an impact on a variable that indicates the number of employees in enterprise 4. In this second example, the impact of this action continues for all subsequent time periods until the hired employee is no longer employed by enterprise 4.

In addition, edit variable pane 212 includes a “forecast propagation” dropdown box 216 that allows user 51 to specify how system 3 is to propagate the forecast for the variable. For instance, “forecast propagation” dropdown box 216 may allow user 51 to specify that system 3 is to add impacts on the variable from time period to time period. Alternative ways of propagating the impacts may include subtracting, dividing, or multiplying impacts on the variable.

Variable editing interface 210 also includes a variable object administration pane 218. Variable object administration pane 218 allows user 51 to perform actions regarding overlay calculations. An overlay calculation specifies how an overlay impact for a variable for a time period is calculated from a base impact and an action impact for the variable and for the time period.

Variable editing interface 210 includes an overlay calculation list 220 that lists overlay calculations that have been configured for the variable. Users 19 may configure multiple overlay calculations for a variable. When one of users 19 configures an overlay calculation for the variable, the overlay calculation may appear in overlay calculation list 220. Users 19 may then use a checkbox next to an overlay calculation in overlay calculation list 220 to apply the overlay calculation when calculating overlay impacts in forecasts that include the variable.

The techniques described herein may be implemented in hardware, software, firmware, or any combination thereof. Any features described as modules or components may be implemented together in an integrated logic device or separately as discrete but interoperable logic devices. If implemented in software, the techniques may be realized at least in part by a computer-readable medium comprising instructions that, when executed, performs one or more of the methods described above. The computer-readable medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code may be executed by one or more processors, such as one or more digital signal processors (DSPs), general purpose microprocessors, an application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein.

Various embodiments of the invention have been described. These and other embodiments are within the scope of the following claims.

1. A computer-implemented method of performing an enterprise planning session, comprising:
receiving model data that defines an enterprise planning model for use within a subsequent enterprise planning session, wherein the model data comprises action data that specifies one or more tasks, and wherein the action data defines: (i) a plurality of task-specific forms to capture task-specific contribution data for the enterprise planning session on a per-task basis, and (ii) a mapping for storing the task-specific contribution data within a database of multidimensional data; and
executing software to conduct the enterprise planning session in accordance with the model at least in part by:
capturing business-as-usual contribution data associated with ordinary operation of the enterprise from a first set of contributors using a spreadsheet interface,
capturing the task-specific contribution data associated with out-of-the-ordinary operations of the enterprise from a second set of contributors using the task-specific forms and storing the task-specific contribution data within the database according to the mapping,
aggregating the task-specific contribution data and the business-as-usual contribution data to form aggregate contribution data for the enterprise planning session, and
generating a composite forecast from the aggregate contribution data.

2. The method of claim 1, wherein the action data specifies chronological dependencies among the tasks.

3. The method of claim 2, further comprising automatically updating the task-specific contribution data associated with at least one of the plurality of tasks in response to the captured task-specific contribution data and the dependencies specified by the action data.

4. The method of claim 3, wherein executing software to conduct the enterprise planning session comprises:
capturing, via at least one of the corresponding task-specific forms, an actual date of occurrence of at least one of the plurality of tasks;
automatically updating one or more target dates of the other tasks based on the actual date and the defined interdependencies; and
automatically recalculating the aggregate contribution data based on the updated target dates.

5. The method of claim 1,
wherein the task-specific contribution data includes data associated with a variable,
wherein the business-as-usual contribution data includes data associated with the variable;
wherein the variable is associated with an overlay calculation; and
wherein aggregating the task-specific contribution data and the business-as-usual contribution data comprises performing the overlay calculation in order to form aggregate contribution data associated with the variable.

6. The method of claim 4, wherein the method further comprises:
presenting a user interface that enables a user to specify the overlay calculation to associate with the variable; and
receiving input from a user of the user interface, wherein the input specifies the overlay calculation to associate with the variable.

7. The method of claim 1, further comprising:
while executing the enterprise planning session, reviewing the contribution data by presenting a task log that describes a plurality of tasks, each of which has an impact on the task-specific contribution data;
updating the aggregate contribution data to reflect impacts on the task-specific contribution data of selected ones of the tasks described by the task log; and
presenting the composite forecast based on the updated aggregate contribution data.

8. The method of claim 7, wherein reviewing the contribution data comprises includes performing a roll-back operation to remove an impact of one of the tasks described in the task log on the task-specific contribution data in response to input from the user.

9. The method of claim 7, wherein selectively reviewing the contribution data comprises performing a “show impact” operation that temporarily shows an impact of one of the tasks described in the task log to the task-specific contribution data.

10. The method of claim 7, further comprising:
presenting a forecast pane that includes a spreadsheet-like or grid view of the aggregate contribution data in conjunction with presenting the task log; and
updating the aggregate contribution data shown within the forecast pane of the action-based contribution data based on selected ones of the tasks described in the task log.

11. The method of claim 1, further comprising automatically invoking one or more applications to issue reminders pertaining to the tasks.

12. The method of claim 1, further comprising storing the captured action-based contribution data to dimensions of the multidimensional data store based on the mapping.

13. The method of claim 1, further comprising configuring the model to define input fields of the task-specific forms.

14. The method of claim 1, wherein executing software to conduct the enterprise planning session further comprises:
presenting a user interface through which a reviewer indicates whether an action defined by the action data was performed; and
automatically generating output representing commentary on the difference between actual and forecasted data based on the indication.

15. The method of claim 13, wherein executing software to conduct the enterprise planning session further comprises automatically generating accrual data based on the difference between the actual and forecasted data based on the indication.

16. The method of claim 1, wherein executing software to conduct the enterprise planning session comprises capturing, via at least one of the corresponding task-specific forms, an ownership of at least one of the plurality of tasks, wherein the ownership indicates permissible contributors of the set of contributors able to enter task data associated with the task.

17. A computing system comprising:
an analysis software module executing on the computing system to receive data that defines an enterprise planning session to be carried out by a set of users associated with a multi-level enterprise hierarchy, wherein the model data comprises action data that specifies one or more tasks, and wherein the action data defines (1) a plurality of task-specific forms to capture task-specific contribution data for the enterprise planning session on a per-task basis, and (ii) a mapping for storing the task-specific contribution data within a database of multidimensional data; and
a contribution module executing on the computing system to conduct the enterprise planning session in accordance with the model at least in part by:
capturing business-as-usual contribution data associated with ordinary operation of the enterprise from a first set of contributors using a spreadsheet interface,
capturing the task-specific contribution data associated with out-of-the-ordinary operations of the enterprise from a second set of contributors using the task-specific forms and storing the task-specific contribution data within the database according to the mapping,
aggregating the task-specific contribution data and the business-as-usual contribution data to form aggregate contribution data for the enterprise planning session, and
generating a composite forecast from the aggregate contribution data.

18. The computing system of claim 17, wherein the action data specifies chronological dependencies among the tasks.

19. The computing system of claim 17, wherein the system automatically updates the task-specific contribution data associated with at least one of the plurality of tasks in response to the captured task-specific contribution data and the dependencies specified by the action data.

20. The computing system of claim 19,
wherein the user interface captures task-specific contribution data by capturing an actual date of occurrence of at least one of the plurality of tasks via at least one of the corresponding task-specific forms,
wherein the system automatically updates one or more target dates of the other tasks based on the actual date and the dependencies, and automatically recalculates the aggregated contribution data based on the updated target dates.

21. The computing system of claim 17,
wherein the task-specific contribution data includes data associated with a variable,
wherein the business-as-usual contribution data includes data associated with the variable;
wherein the variable is associated with an overlay calculation; and
wherein the contribution module aggregates the task-specific contribution data and the business-as-usual contribution data at least in part by performing the overlay calculation in order to form aggregate contribution data associated with the variable.

22. The computing system of claim 21, wherein the system further comprises an application executing on the computing system that presents a user interface that enables a user to specify the overlay calculation to associate with the variable and that receives input from a user of the user interface, wherein the input specifies the overlay calculation to associate with the variable.

23. The computing system of claim 17, wherein the system presents a user interface having a task log that describes a plurality tasks, each of which has an impact on the task-specific contribution data,
wherein the system updates the aggregate contribution data to reflect impacts on the task-specific contribution data of selected ones of the tasks described by the task log, and
wherein the user interface outputs a composite forecast based on the updated aggregate contribution data.

24. The computing system of claim 23, wherein, in response to the input, the system performs a roll-back operation to remove an impact of one of the tasks described in the task log and updates the aggregated contribution data accordingly.

25. The computing system of claim 23, wherein the system selectively accepts one or more of the sequential plurality of pending changes by performing a “show impact” operation to temporarily show an impact of one of the tasks described in the task log on the task-specific contribution data and outputs adjusted task-specific contribution data.

26. The computing system of claim 17, wherein the system stores the captured task-specific contribution data to dimensions of the multidimensional data store based on the mapping.

27. The computing system of claim 17, wherein the system receives input from a user to configure the action data to define fields of the task-specific forms and time-based dependencies of the tasks.

28. The computing system of claim 17, wherein the multidimensional data store resides on a server and a client device presents the user interface.

29. The computing system of claim 17,
wherein the contribution module further presents a user interface through which a user indicates whether an action defined by the action data was performed, and
wherein the system further includes a report generator module that automatically generates commentary on the difference between actual and forecasted data based on the indication.

30. The computing system of claim 17, wherein the system further includes a report generator module that automatically generates accrual data on a difference between actual and forecasted data.

31. The computing system of claim 17, wherein contribution module captures the task-specific contribution data from the users using the task-specific forms by capturing, via at least one of the corresponding task-specific forms, an ownership of at least one of the tasks, wherein the ownership indicates permissible users able to enter task-specific data associated with the at least one of the tasks.

32. A computer-readable medium comprising instructions, the instructions causing a programmable processor to:
retrieve model data that defines an enterprise planning model for use within a subsequent enterprise planning session, wherein the model data comprises action data that specifies one or more tasks, and wherein the action data defines: (i) a plurality of task-specific forms to capture task-specific contribution data for the enterprise planning session on a per-task basis, and (ii) a mapping for storing the task-specific contribution data within a database of multidimensional data; and
execute software to conduct the enterprise planning session in accordance with the model at least in part by causing the programmable processor to:
capture business-as-usual contribution data associated with ordinary operation of the enterprise from a first set of contributors using a spreadsheet interface,
capture the task-specific contribution data associated with out-of-the-ordinary operations of the enterprise from a second set of contributors using the task-specific forms and storing the task-specific contribution data within the database according to the mapping,
aggregate the task-specific contribution data and the business-as-usual contribution data to form aggregate contribution data for the enterprise planning session, and
generate a composite forecast from the aggregate contribution data.

33. The computer-readable medium of claim 32, wherein the action data specifies chronological dependencies among the tasks.

34. The computer-readable medium of claim 32,
wherein the task-specific contribution data includes data associated with a variable,
wherein the business-as-usual contribution data includes data associated with the variable;
wherein the variable is associated with an overlay calculation; and
wherein the instructions cause the programmable processor to aggregate the task-specific contribution data and the business-as-usual contribution data at least in part by causing the programmable processor to perform the overlay calculation in order to form aggregate contribution data associated with the variable.
